(19) United States
(12) Patent Application Publication
(10) Pub. No.: US 2026/0330719 A1
(43) Pub. Date: Oct. 22, 2026

(54) PERSONALIZED VISION AND LANGUAGE GENERATION

(71) Applicant: ADOBE INC., SAN JOSE, CA (US)

(72) Inventors: Thao Nguyen, Madison, WI (US); Krishna Kumar Singh, San Jose, CA (US); Jing Shi, San Jose, CA (US); Trung Huu Bui, San Jose, CA (US); Yuheng Li, San Jose, CA (US)

(21) Appl. No.: 19/181,712

(22) Filed: Apr. 17, 2025

(51) Int. Cl. G06T 11/60; G06F 40/284; G06V 10/77; G06V 10/774; G06V 10/82

(52) U.S. Cl. CPC G06T 11/60; G06F 40/284; G06V 10/7715; G06V 10/82; G06V 10/774

(57) ABSTRACT

A method, apparatus, non-transitory computer readable medium, and system for multimodal generation include obtaining an input image and an image generation prompt, where the input image depicts a view of an object and the image generation prompt describes a different view of the object, generating a set of custom tokens based on the input image, where the set of custom tokens includes an image generation token and an image understanding token and generating a synthetic image based on the image generation prompt and the image generation token, where the synthetic image depicts the different view of the object described by the image generation prompt and preserves an identity of the object from the input image.

### BACKGROUND

The following relates generally to multimodal processing, and more specifically to personalized multimodal generation using a generative machine learning model. Multimodal processing refers to using a computer system to process and interpret information from multiple types of data, such as text, images, audio, and video, through a single model. In some cases, multimodal systems are used for various tasks, such as visual question answering, image captioning, speech-to-text conversion, and multimodal content generation (e.g., image generation or text generation). For example, a multimodal machine learning model can generate a synthetic image based on an input text description, interpret visual content in response to a text-based query, or produce a video by combining audio and images. In some cases, multimodal processing may include applications such as cross-modal retrieval and contextual learning.

In the field of multimodal processing, vision-language processing refers to the integration of text and visual data to improve understanding and generation tasks. For example, a machine learning model may receive an image and a question about the image and generate a textual response based on the visual content. Additionally, vision-language models can generate new images based on a descriptive text prompt. However, conventional multimodal systems often struggle with maintaining consistency across modalities, resulting in inaccurate descriptions, misplaced object associations, or failure to generalize across diverse input types.

### SUMMARY

Embodiments of the present disclosure provide a method and system for multimodal processing, and more specifically for multimodal generation using a generative machine learning model. In one aspect, the system is trained to perform image generation task and language generation task. The system receives one or more input images (e.g., 3-5 images) depicting an object and a prompt to perform a multimodal task. In one aspect, the system is trained to generate a set of tokens based on the input image. For example, the set of tokens include, a nonce token, a learnable image token (e.g., image generation token) and a learnable text token (e.g., an image understanding token). The nonce token identifies the object depicted in the input image. The learnable image token is trained to encode visual characteristics of the input image and to perform image generation. The learnable text token is trained to perform image understanding task such as text query answering or image answering. In one aspect, the system is further trained to select and perform a task based on the prompt. When selecting a task, the system uses the corresponding learnable image token or the learnable text token to perform the correct function. Accordingly, the system can accurately perform an image generation task or a text generation task that depict or describe the object from the input image.

A method, apparatus, non-transitory computer readable medium, and system for multimodal generation include obtaining an input image and an image generation prompt, where the input image depicts a view of an object and the image generation prompt describes a different view of the object, generating a set of custom tokens based on the input image, where the set of custom tokens includes an image generation token and an image understanding token and generating, using a multimodal generation model, a synthetic image based on the image generation prompt and the image generation token, where the synthetic image depicts the different view of the object described by the image generation prompt and preserves an identity of the object from the input image.

A method, apparatus, non-transitory computer readable medium, and system for multimodal generation include obtaining an input image and an image understanding prompt, wherein the input image depicts an object and the image understanding prompt comprises a question about the input image, generating a set of custom tokens based on the input image, wherein the set of custom tokens includes an image understanding token and an image generation token, and generating, using a multimodal generation model, a response to the image understanding prompt based on the image understanding token, wherein the response includes an answer to the question.

An apparatus and system for multimodal generation include a memory component, a processing device coupled to the memory component, the processing device configured to perform operations comprising: obtaining an input image and an image generation prompt, wherein the input image depicts a view of an object and the image generation prompt describes a different view of the object, generating a set of custom tokens based on the input image, wherein the set of custom tokens includes an image generation token and an image understanding token, and generating a synthetic image based on the image generation prompt and the image generation token, wherein the synthetic image depicts the different view of the object described by the image generation prompt and preserves an identity of the object from the input image.

### BRIEF DESCRIPTION OF THE DRAWINGS

FIG. 1 shows an example of a multimodal processing system according to aspects of the present disclosure.

FIG. 2 shows an example of a method for conditional multimodal generation according to aspects of the present disclosure.

FIG. 3 shows an example of a method for image generation task using an image generation token according to aspects of the present disclosure.

FIG. 4 shows an example of a method for language generation task using an image understanding token according to aspects of the present disclosure.

FIG. 5 shows an example of a method for generating image generation tokens according to aspects of the present disclosure.

FIG. 6 shows an example of multimodal image question answering according to aspects of the present disclosure.

FIG. 7 shows an example of multimodal text generation according to aspects of the present disclosure.

FIG. 8 shows an example of multimodal image generation according to aspects of the present disclosure.

FIG. 9 shows an example of a machine learning model according to aspects of the present disclosure.

FIG. 10 shows an example of a transformer architecture according to aspects of the present disclosure.

FIG. 11 shows an example of an image generation model according to aspects of the present disclosure.

FIG. 12 shows an example of a U-Net architecture according to aspects of the present disclosure.

FIG. 13 shows an example of a diffusion transformer model according to aspects of the present disclosure.

FIG. 14 shows an example of a diffusion process according to aspects of the present disclosure.

FIG. 15 shows an example of image token reconstruction according to aspects of the present disclosure.

FIG. 16 shows an example of learning image generation tokens according to aspects of the present disclosure.

FIG. 17 shows an example of a flow diagram depicting an algorithm as a step-by-step procedure in an example implementation of operations performable for training a machine learning model according to aspects of the present disclosure.

FIG. 18 shows an example of a method for training a diffusion model according to aspects of the present disclosure.

FIG. 19 shows an example of a multimodal processing apparatus according to aspects of the present disclosure.

FIG. 20 shows an example of a computing device according to aspects of the present disclosure.

### DETAILED DESCRIPTION

The following relates to multimodal generation using a generative machine learning model. Embodiments of the present disclosure relate to a multimodal generation system that can accurately generate an output (e.g., a synthetic image or a text response) that accurately describe or depict the object from an input image and an input prompt. In one aspect, the system is trained to perform both an image generation task and a language generation task. The system receives one or more input images (e.g., 3-5 images) depicting an object and an input prompt to perform a multimodal task. To process the input, the system generates a set of tokens that encode information about the object depicted in the image. This set of tokens includes a nonce token, a learnable image token (image generation token), and a learnable text token (image understanding token). The nonce token uniquely identifies the object depicted in the input image, ensuring that the system can recognize and recall the subject across multiple queries. The learnable image token is trained for encoding the visual features of the input image, enabling the system to generate new images that preserve the distinctive attributes of the object depicted in the input image. The learnable text token is trained for processing language-based tasks, such as answering questions about the object or describing the object in natural language.

In one aspect, the system is further trained to automatically select and execute the appropriate task based on the received prompt. For example, if the prompt describes an image generation task (e.g., “Generate an image of <object> wearing sunglasses”), the system uses the learnable image token which includes the encoded visual characteristics of the object to generate an accurate and visually consistent synthetic image. Similarly, if the prompt describes a text-based understanding task (e.g., “Describe <object>” or “Where is <object> in this image?”), the system uses the learnable text token to generate a textual response that answers the question or task described in the prompt. By performing the task selection, the system can accurately switch between image generation and language generation while maintaining the identity of the object from the input image. By using the set of tokens, the system enhances multimodal personalization, which enables the system to generate and describe objects with minimal training data while preserving the pre-trained knowledge of the model.

A subfield in multimodal generation relates to personalize image and text generation. For example, multimodal generation refers to simultaneously process and generate content across multiple data modalities, such as text, images, audio, and video using a single model. Unlike single-modal systems that handle only one type of input (e.g., text, image, audio, or video), multimodal generative models integrate information from different sources to generate context-aware outputs. For example, a text-to-image generation model can generate an image based on a text description. Some multimodal systems use techniques such as token-based representations, cross-modal alignment, and generative adversarial learning to ensure consistency between different data types. However, these systems raise issues such as semantic misalignment, data scarcity, and inefficient task switching that affects the quality of multimodal outputs.

In some conventional systems, multimodal personalization may be relied on fine-tuning the entire system. For example, in full-model fine-tuning, a generative model (or system) is re-trained on a set of personalized images and text descriptions. This technique enables the convention model to memorize and generate subject-specific details with high accuracy. However, fine-tuning large-scale models is computationally expensive and requires extensive resources such as training datasets. Furthermore, these systems may lead to forgetting, where the model loses the general knowledge as a result of the newly learned information. As a result, training the entire model is impractical for real-world applications where users provide only a small number of images for personalization.

Another conventional method is soft-prompt tuning, where additional trainable parameters (soft prompts) are introduced to personalize the model while keeping the core architecture frozen. While soft-prompt tuning is more efficient than full-model fine-tuning, these methods fail to effectively personalize both image generation and text-based understanding simultaneously. For example, many vision-language models, such as LLaVA, use soft prompts to learn user-specific objects in text-based queries, but these models do not extend personalization to image generation. In some cases, by apply soft prompts for both text and image generation lead to suboptimal performance, as optimizing prompts for one task (e.g., answering questions about an object) does not transfer well to another task (e.g., generating an image of the same object). This task incompatibility results in poor-quality image synthesis and inaccurate textual descriptions. Additionally, some conventional methods do not account for data scarcity, leading to lower accuracy when only a few subject images are available.

Embodiments of the present disclosure improve on conventional multimodal generation models by accurately generating both textual and visual representations of a personalized object depicted in an input image with minimal training data. This is achieved using a system that includes a custom token architecture, where the system receives an input image depicting an object to generate a nonce token, a learnable image token, and a learnable text token. The nonce token uniquely identifies the object, ensuring consistent recognition across multiple tasks (e.g., image generation task or language generation task). The learnable image token encodes the fine-grained visual attributes (e.g., shape, color, texture) of the object for high-fidelity image generation, and the learnable text token is trained to support language-based understanding, enabling the system to describe or answer questions about the object depicted in the input image.

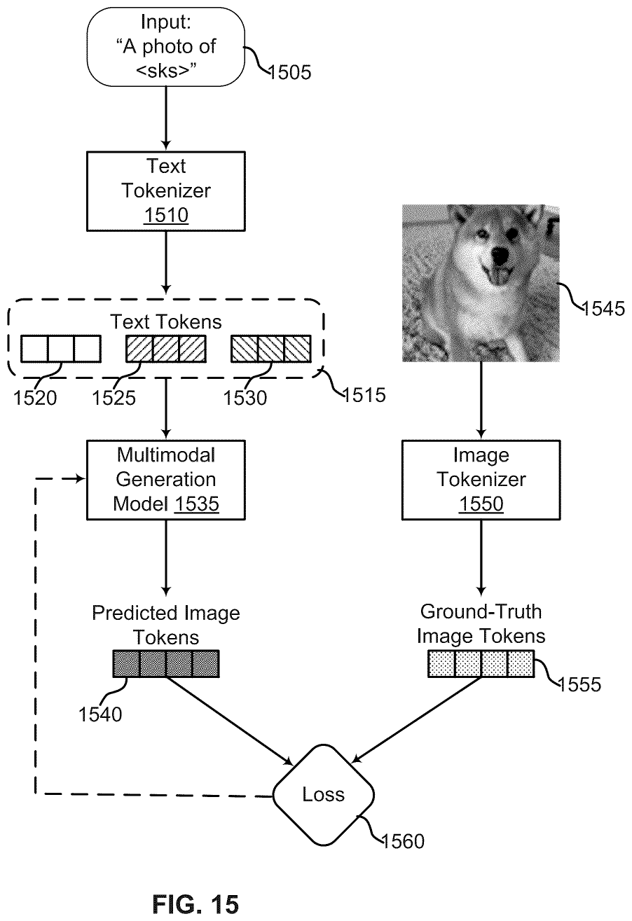

In one aspect, the system further includes a self-prompting mechanism that determines the nature of the task described in the prompt and selects the corresponding token for generation. For example, when the input prompt describes image generation, the system uses the learnable image token to generate a synthetic image that preserves the identity and visual features of the object from the input image. When the input describes text-based understanding, the system uses the learnable text token to generate descriptions or answer queries accurately. By using a soft-positive training method, the system enhances learning efficiency by incorporating visually similar reference images, reducing the need for extensive training data. By combining dual soft prompts with adaptive task selection, the system is able to generate highly personalized outputs without full model fine-tuning, ensuring both efficiency and preservation of the general knowledge of the model. Further detail on soft-positive training method is described with reference to FIG. 15.

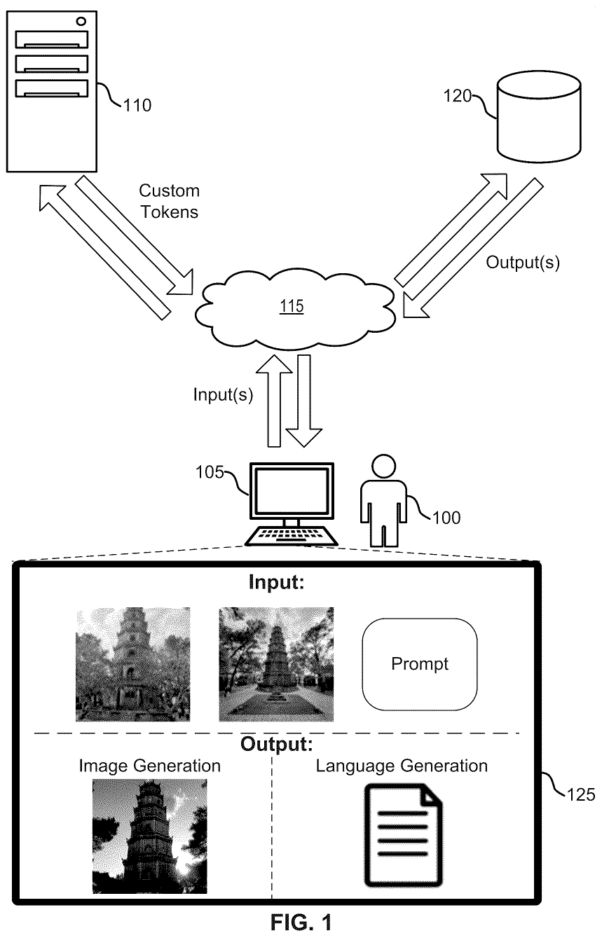

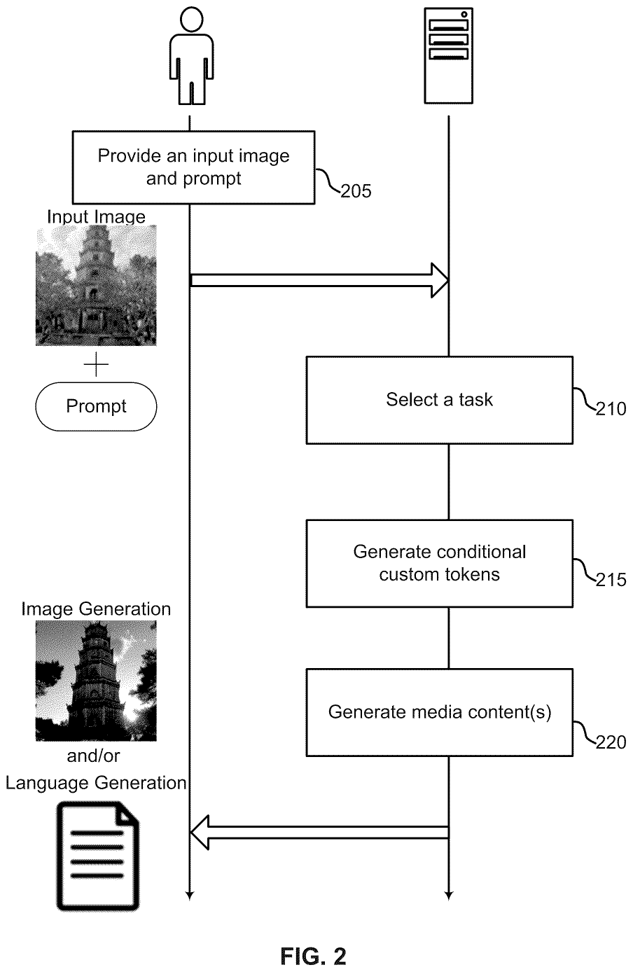

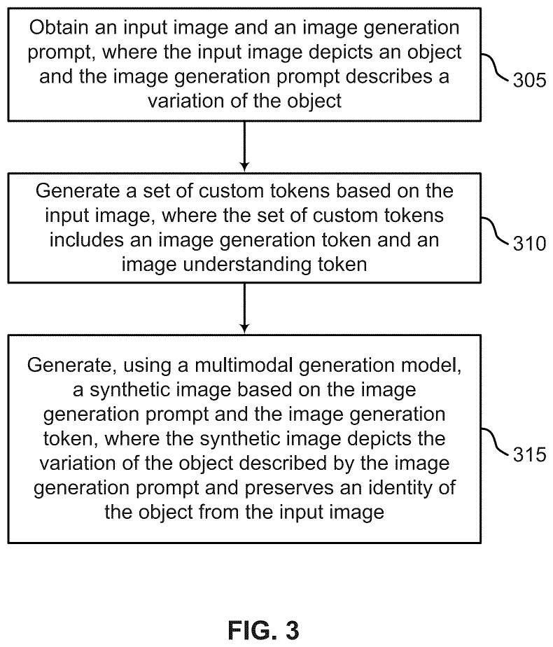

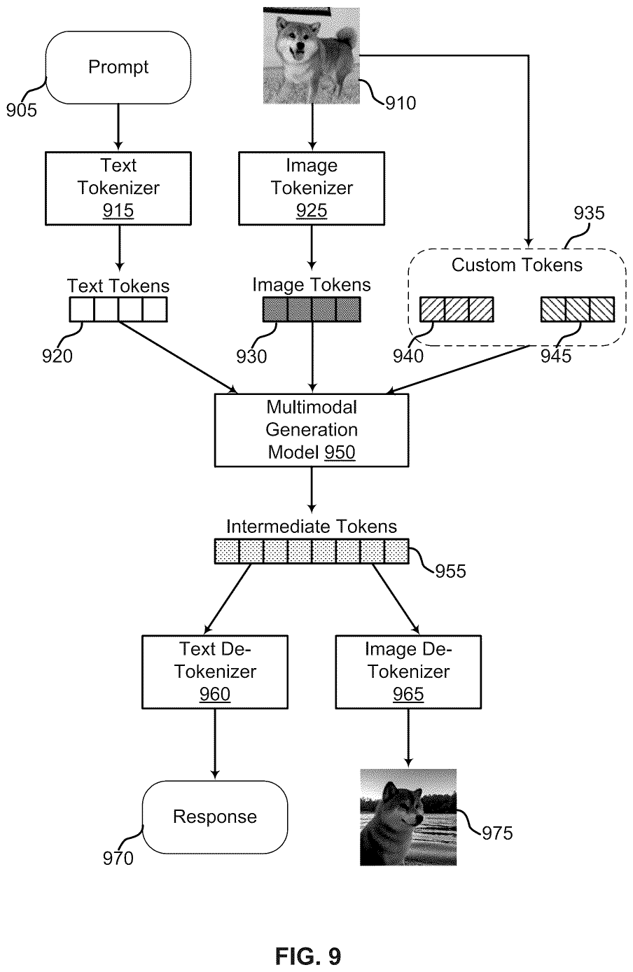

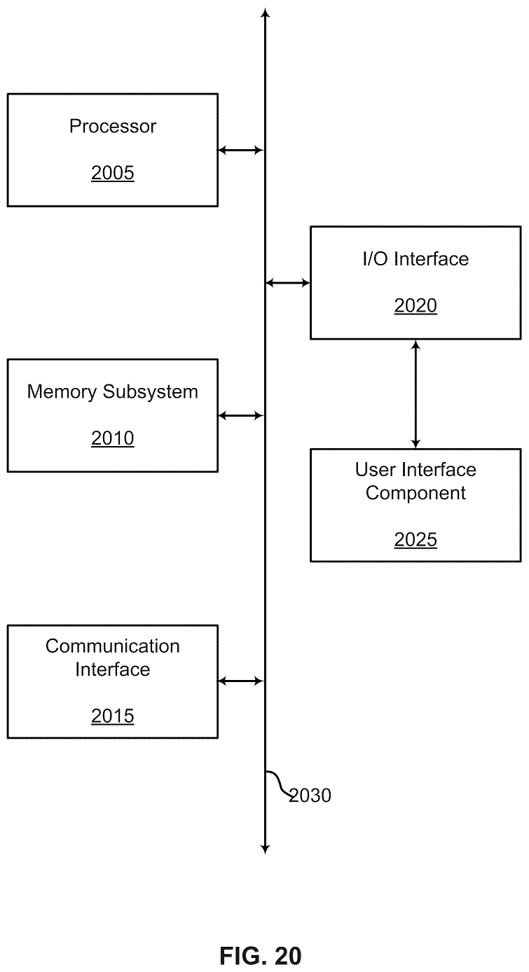

An example system of the present disclosure in image processing is provided with reference to FIGS. 1 and 20. An example application of the present disclosure in image processing is provided with reference to FIGS. 2 and 6-8. Details regarding the architecture of an image processing apparatus are provided with reference to FIGS. 9-13 and 19. An example of a process for image processing is provided with reference to FIGS. 3-5 and 14. A description of an example training process is provided with reference to FIG. 15-18.

Accordingly, the present disclosure provides a system and method that improves on conventional image generation systems by accurately generating both textual and visual representations of a personalized object depicted in an input image with minimal training data. By personalizing the system with one or more input images or reference images, the system can generate user-specific content in both text and image modalities without extensive fine-tuning. Using 3-5 input images, the system can generate consistent outputs while preserving the general knowledge of the model. By implementing a soft-positive learning method with dynamic prompt length, the system enhances image quality and ensures better generalization with minimal input data. Additionally, the use of self-prompting mechanism enables the system to automatically select the correct modality (e.g., image generation or text generation), ensuring both visual consistency in image generation and semantic accuracy in text-based responses.

As used herein, input image may be referred to as a reference image. For example, the input image may depict an object, people, scenes, or abstract patterns that serve as a reference for recognition, generation, or transformation tasks.

A prompt is an input instruction given to a machine learning model to generate a specific output, such as text or images. In one aspect, the prompt may include an image generation prompt, a language generation prompt, or both. An image generation prompt instructs the model to generate a synthetic image based on a text description and/or an input image, incorporating attributes like objects, colors, and styles (e.g., “Generate an image of a golden retriever on a beach at sunset”). A language generation prompt instructs the model to produce textual responses, such as descriptions, answers, or summaries (e.g., “Describe the dog in this image.”).

A token is a unit of data representation in machine learning models, used to encode information from text, images, audio, video, or other modalities. In language generation models, tokens represent words, sub-words, or characters. In multimodal systems, tokens can also encode visual features of an image, which enables the system to understand and generate images. In some aspects, the set of custom tokens includes image generation tokens, which store fine-grained visual attributes for personalized image synthesis, and language generation tokens, which encode semantic details for accurate text-based descriptions and question answering.

A different view of an object refers to a modified version of an object from an input, typically differing in certain attributes while retaining core characteristics. For example, in image generation, different views may include changes in pose, lighting, perspective, context, background, or artistic style while preserving the identity of the object from input image. In language generation, a different view may be represented by rewording a sentence, changing the tone, or altering the format, or describing a different context while maintaining aspects of the original meaning. In multimodal generation, different views include the modification of a scene, an attribute of the object consistent with the description from the input prompt.

Accordingly, in some embodiments of the disclosure a first view of an object can be depicted in an image with a set of attributes corresponding to the first view including a particular pose, lighting, perspective, context, background, or artistic style. A second view different from the first view can be described by an image generation prompt that specifies different attributes such as a different pose, lighting, perspective, context, background, or artistic style from the first view. An image generation model generates a synthetic image based on the input image and input prompt. The synthetic image can depict the object from the input image with the differences specified by the prompt. At the same time, the synthetic image preserves the identity of the object by retaining structural attributes or identifying attributes of the object.

A nonce token refers to a token assigned to an object or subject in an input image, which enables the model to recognize and recall the specific entity across different tasks. For example, the nonce token ensures that identified object is consistently referenced in both image and text generation tasks. In some cases, a nonce token does not store visual or textual details but instead acts as a placeholder, linking the entity to the corresponding learnable image and text tokens. Nonce token enables the model to generate coherent and context-aware outputs while maintaining the identity of the object depicted in the input image.

### Multimodal Generation

In FIGS. 1-8, and 14, a method, apparatus, non-transitory computer readable medium, and system for multimodal generation include obtaining an input image and an image generation prompt, where the input image depicts an object and the image generation prompt describes a different view of the object, generating a set of custom tokens based on the input image, where the set of custom tokens includes an image generation token and an image understanding token and generating, using a multimodal generation model, a synthetic image based on the image generation prompt and the image generation token, where the synthetic image depicts the different view of the object described by the image generation prompt and preserves an identity of the object from the input image.

Some examples of the method, apparatus, non-transitory computer readable medium, and system further include dividing a set of reference images into a plurality of groups based on the input image, wherein each of the plurality of groups is progressively more similar to the input image. Some examples further include generating a plurality of image generation tokens corresponding to the plurality of groups respectively, wherein the synthetic image is generated based on the plurality of image generation tokens.

Some examples of the method, apparatus, non-transitory computer readable medium, and system further include selecting an image generation task based on the image generation prompt. Some examples further include selecting the image generation token for generating the synthetic image based on the image generation task.

In some aspects, the image generation prompt includes a nonce token representing the object in the input image. In some aspects, the multimodal generation model is trained to select from among an image generation task and an image understanding task. In some aspects, the multimodal generation model is trained to perform an image generation task based on the image generation token and to perform an image understanding task based on the image understanding token. In some aspects, the image generation token is based on an image reconstruction loss.

Some examples of the method, apparatus, non-transitory computer readable medium, and system further include obtaining an image understanding prompt comprising a question about the input image. Some examples further include generating, using the multimodal generation model, a response to the image understanding prompt based on the image understanding token, wherein the response includes an answer to the question.

According to some embodiments, a method, apparatus, non-transitory computer readable medium, and system for multimodal generation include obtaining an input image and an image understanding prompt, wherein the input image depicts an object and the image understanding prompt comprises a question about the input image, generating a set of custom tokens based on the input image, wherein the set of custom tokens includes an image understanding token and an image generation token, and generating, using a multimodal generation model, a response to the image understanding prompt based on the image understanding token, wherein the response includes an answer to the question.

Some examples of the method, apparatus, non-transitory computer readable medium, and system further include selecting an image understanding task based on the image understanding prompt. Some examples further include selecting the image understanding token for generating the response based on the image understanding task.

In some aspects, the image understanding prompt includes a nonce token representing the object in the input image. In some aspects, the multimodal generation model is trained to select from among an image generation task and an image understanding task. In some aspects, the multimodal generation model is trained to perform an image generation task based on the image generation token and to perform an image understanding task based on the image understanding token. In some aspects, the image generation token is based on an image reconstruction loss.

Some examples of the method, apparatus, non-transitory computer readable medium, and system further include obtaining an image generation prompt describing a different view of the object. Some examples further include generating, using the multimodal generation model, a synthetic image based on the image generation prompt and the image generation token, wherein the synthetic image depicts the different view of the object described by the image generation prompt and preserves an identity of the object from the input image.

Some examples of the method, apparatus, non-transitory computer readable medium, and system further include dividing a set of reference images into a plurality of groups based on the input image, wherein each of the plurality of groups is progressively more similar to the input image. Some examples further include generating a plurality of image generation tokens corresponding to the plurality of groups respectively, wherein the synthetic image is generated based on the plurality of image generation tokens.

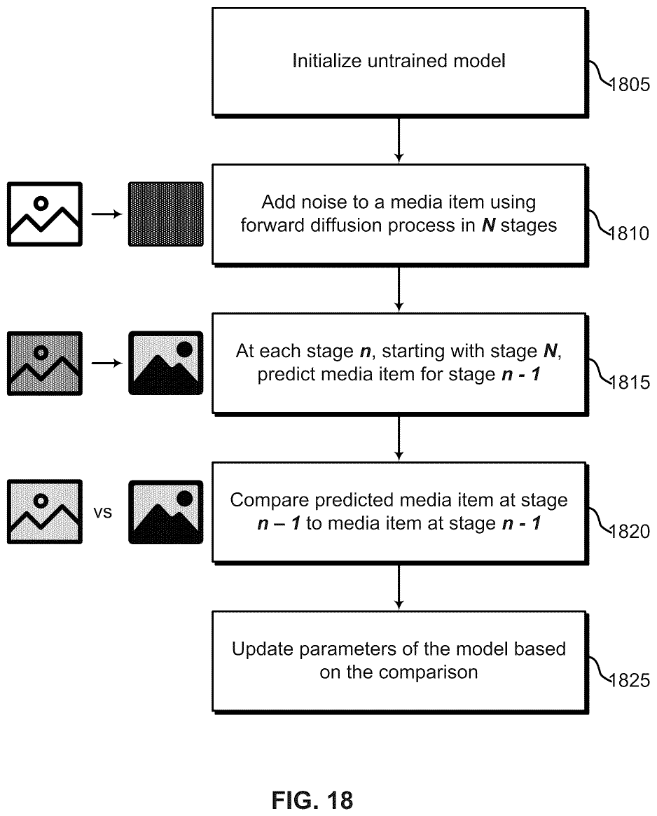

FIG. 1 shows an example of a multimodal processing system according to aspects of the present disclosure. The example shown includes user 100, user device 105, multimodal processing apparatus 110, cloud 115, database 120, and display device 125. Multimodal processing apparatus 110 is an example of, or includes aspects of, the corresponding element described with reference to FIG. 18.

Referring to FIG. 1, user 100 provides one or more input images and a prompt to multimodal processing apparatus 110 via a display device 125 of user device 105 through cloud 115 to perform image generation and/or language generation. In some cases, user 100 may provide one or more images depicting an object (e.g., an architecture) to the multimodal processing apparatus 110. Additionally, the user 100 may provide one or more prompts to the multimodal processing apparatus 110 to provide command to the multimodal processing apparatus 110 to perform one or more tasks. For example, the prompt may be an image generation prompt instructing the multimodal processing apparatus 110 to perform image generation task. For example, the prompt may be a language generation prompt instructing the multimodal processing apparatus 110 to perform language generation such as visual question answering or text-only conversation.

In one aspect, the multimodal processing apparatus 110 includes a machine learning model that processes the inputs and generates a synthetic image and/or a text response based on the task indicated by the prompt. In one aspect, the machine learning model includes a multimodal generation model configured to generate customs tokens based on the input image. For example, the custom tokens includes a nonce token configured to identify the object depicted in the input image(s), an image generation token trained to perform image generation task, and an image understanding token trained to perform language generation.

In some aspects, the image generation token encodes visual characteristics of the object depicted in the input image and enables the multimodal generation model to generate a synthetic image that preserves the identity of the object from the input image. Additionally, the image generation token is trained to by progressively assigning training images with more details close to the input image to more image generation tokens. For example, one image generation token may be trained to represent an object (e.g., a dog), whereas three image generation tokens may be trained to represent an object having additional features (e.g., a dog with brown fur with smooth texture).

In some aspects, the image understanding tokens encode textual knowledge about the object depicted in the input image and enables the multimodal generation model to generate textual responses that recognize, describe, and/or answers questions about the object depicted in the input image. For example, the image understanding tokens are trained using image-based question and answer pairs for context learning.

According to some embodiments, the multimodal processing apparatus 110 determines whether a task based on the prompt provided by the user 100. For example, when the multimodal processing apparatus 110 determines that an image generation task is to be performed, then the multimodal processing apparatus 110 uses the image generation tokens to generate a synthetic image that depicts a different view of the object described by the prompt. For example, when the multimodal processing apparatus 110 determines that an image understanding task is to be performed, the multimodal processing apparatus 110 uses the image understanding token to generate a text response that answers the question from the prompt. In one aspect, the synthetic image or the textual response is provided to the user 100 via display device 125 and cloud 115.

User device 105 may be a personal computer, laptop computer, mainframe computer, palmtop computer, personal assistant, mobile device, or any other suitable processing apparatus. In some examples, user device 105 includes software that incorporates a multimodal processing application. In some examples, the multimodal processing application on user device 105 may include functions of multimodal processing apparatus 110. In some cases, user device 105 may include a user interface that performs functions of the multimodal processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the multimodal processing apparatus 110 is further described with reference to FIG. 2.

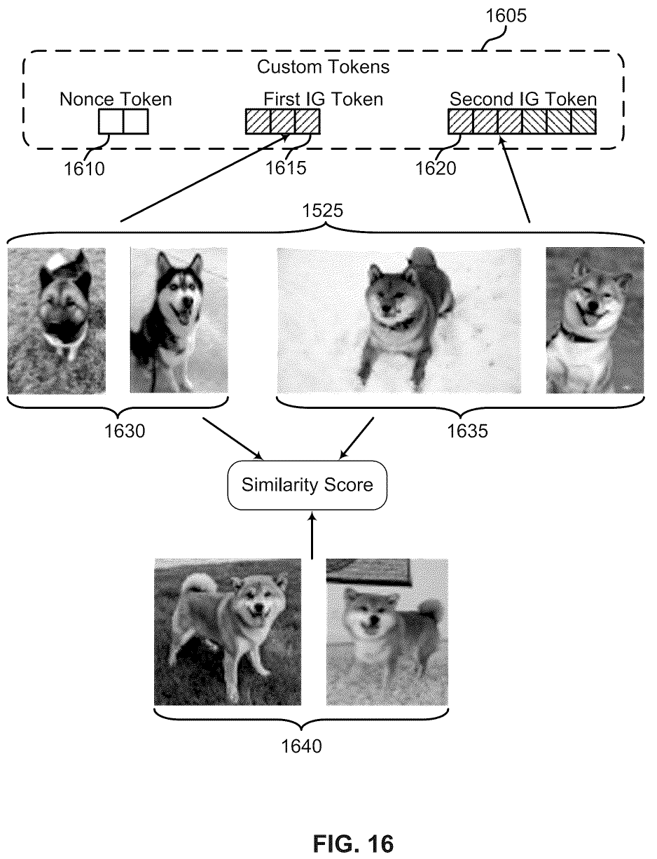

Multimodal processing apparatus 110 is an example of, or includes aspects of, the corresponding element described with reference to FIG. 16. According to some aspects, multimodal processing apparatus 110 includes a computer implemented network comprising a machine learning model, an image encoder, keypoint detection model, warping model, and an image generation model. Multimodal processing apparatus 110 further includes a processor unit, a memory unit, an I/O module, a user interface, and a training component. In some embodiments, multimodal processing apparatus 110 further includes a communication interface, user interface components, and a bus as described with reference to FIG. 20. Additionally or alternatively, multimodal processing apparatus 110 communicates with user device 105 and database 120 via cloud 115. Further detail regarding the operation of multimodal processing apparatus 110 is described with reference to FIG. 2.

In some cases, multimodal processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In some examples, cloud 115 is based on a local collection of switches in a single physical location.

According to some aspects, database 120 stores a plurality of training images and the input image. In some aspects, database 120 stores synthetic image generated from the image generation model. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method for conditional multimodal generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, a user provides input image and prompt. In some cases, the operations of this step refer to, or may be performed by, a user as described with reference to FIG. 1. In an embodiment, one or more input images depicting a same object is provided to the system. For example, input image serves as a reference, depicting an object that the system will process for either image generation or text-based understanding. The prompt specifies the task to be performed, such as generating a new image of the object in a different different view or providing a textual description of the object.

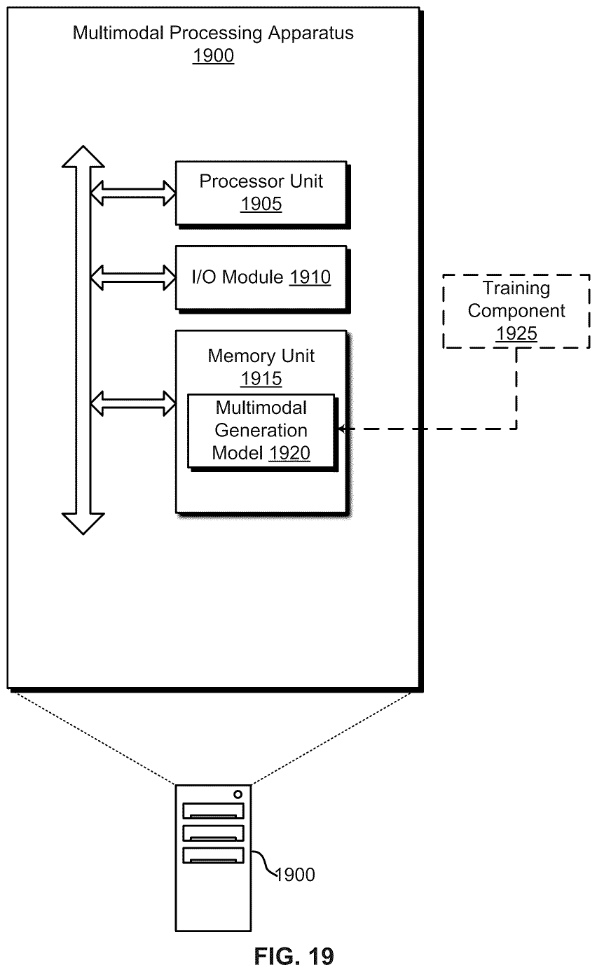

At operation 210, the system selects a task. In some cases, the operations of this step refer to, or may be performed by, a multimodal processing apparatus as described with reference to FIGS. 1 and 19. For example, if the prompt requests “Generate an image of this pet in a park,” the system selects an image generation task. If the prompt states “Describe the fur color of this pet,” the system selects a text-based understanding task. This task selection mechanism ensures that the model uses the corresponding learnable tokens for optimal multimodal processing.

At operation 215, the system generates conditional custom tokens. In some cases, the operations of this step refer to, or may be performed by, a multimodal processing apparatus as described with reference to FIGS. 1 and 19. For example, the system generates conditional custom tokens that encode personalized information about the object depicted in the input image. These tokens may include a nonce token, which uniquely identifies the subject, a learnable image token, which encodes visual details for image generation, and a learnable text token, which stores semantic attributes for text-based queries. The system dynamically adjusts these tokens based on the prompt, ensuring that personalized content is generated with high accuracy while maintaining the general knowledge of the system.

At operation 220, the system generates media content. In some cases, the operations of this step refer to, or may be performed by, a multimodal processing apparatus as described with reference to FIGS. 1 and 19. In some cases, the media content includes a synthetic image, a text response, or a combination thereof. For example, the system generates media content based on the task described by the prompt and the custom tokens. When the task involves image generation, the system generates a synthetic image that depicts the object having different views described by the text prompt. If the task involves language-based generation, the system generates a textual response that accurately describes or answers queries about the object in the input image.

FIG. 3 shows an example of a method for image generation task using an image generation token according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 305, the system obtains an input image and an image generation prompt, where the input image depicts an object and the image generation prompt describes a different view of the object. In some cases, the operations of this step refer to, or may be performed by, a multimodal generation model as described with reference to FIGS. 9, 15, and 19. For example, the different view may include a change in pose, background, lighting, or style described by the image generation prompt. For example, the input image may depict a golden retriever sitting indoors, and the image generation prompt may state “Generate an image of this dog sitting in a park.”

At operation 310, the system generates a set of custom tokens based on the input image, where the set of custom tokens includes an image generation token and an image understanding token. In some cases, the operations of this step refer to, or may be performed by, a multimodal generation model as described with reference to FIGS. 9, 15, and 19. The image generation token encodes fine-grained visual details (e.g., texture, color, shape) of the object from the input image to ensure consistency in the output image, and the image understanding token captures semantic attributes that help preserve the identity of the object across multimodal tasks. In some cases, the image generation token and the image understanding token act as embeddings that enables the system to generate subject-specific content (i.e., preserving the identity of the object).

At operation 315, the system generates, using a multimodal generation model, a synthetic image based on the image generation prompt and the image generation token, where the synthetic image depicts the different view of the object described by the image generation prompt and preserves an identity of the object from the input image. In some cases, the operations of this step refer to, or may be performed by, a multimodal generation model as described with reference to FIGS. 9, 15, and 19. In some cases, the synthetic image depicts the object having the different view described by the image generation prompt. For example, if the input image depicts a specific pet and the prompt states an image of the same pet in a different scene, the synthetic image may depict the specific pet having the same characteristics in the scene described by the image generation prompt.

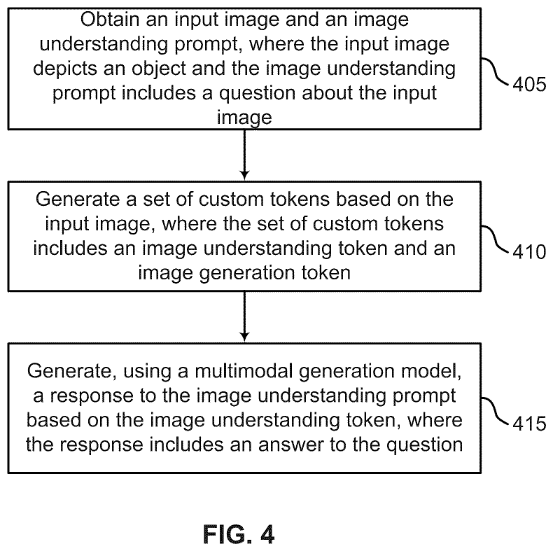

FIG. 4 shows an example of a method for language generation task using an image understanding token according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the system obtains an input image and an image understanding prompt, where the input image depicts an object and the image understanding prompt includes a question about the input image. In some cases, the operations of this step refer to, or may be performed by, a multimodal generation model as described with reference to FIGS. 9, 15, and 19. For example, the question may inquire about specific attributes, such as the color, shape, or location of the object, or seek a more detailed description of the scene. For example, if the input image depicts a dog sitting in a garden, the prompt could be “What breed is the dog in the image?” or “Where is the dog located?”. In some cases, the multimodal generation model processes the image and the image understanding prompt to determine the relevant visual and semantic information for generating an accurate response.

At operation 410, the system generates a set of custom tokens based on the input image, where the set of custom tokens includes an image understanding token and an image generation token. In some cases, the operations of this step refer to, or may be performed by, a multimodal generation model as described with reference to FIGS. 9, 15, and 19. For example, the image understanding token encodes key semantic attributes from the image, such as object identity, spatial relationships, and descriptive features, enabling the model to provide accurate text-based answers. Additionally, the image generation token acts as personalized representations that enable the system to retain subject-specific details while ensuring precise responses to text-based queries.

At operation 415, the system generates, using a multimodal generation model, a response to the image understanding prompt based on the image understanding token, where the response includes an answer to the question. In some cases, the operations of this step refer to, or may be performed by, a multimodal generation model as described with reference to FIGS. 9, 15, and 19. For example, if the system receives an input image of a cat on a couch and the question “What color is the cat?”, the system uses the image understanding token to extract color-related features and provides an accurate response (e.g., “The cat is orange with white stripes.”).

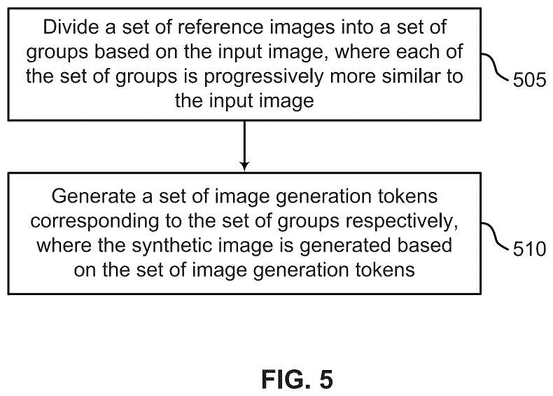

FIG. 5 shows an example of a method for generating image generation tokens according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system divides a set of reference images into a set of groups based on the input image, where each of the set of groups is progressively more similar to the input image. In some cases, the operations of this step refer to, or may be performed by, a multimodal generation model as described with reference to FIGS. 9, 15, and 19. During the training stage (or fine-tuning stage), by grouping the reference images based on the similarity prioritizes images that share key characteristics such as color, texture, shape, or composition with the input image. For example, if the input image depicts a specific dog breed, the reference images may be divided into high-similarity groups (same breed, similar pose) and lower-similarity groups (different breeds or slight variations in appearance). This hierarchical approach ensures that the system effectively learns from gradually increasing levels of similarity, and trains the set of customs tokens to encode more visual information. For example, one custom token (either image generation token or image understanding token) may encode the high-level semantics or visual feature of the object, and three tokens may encode specific feature (e.g., color, texture, gradient, etc.) of the object.

At operation 510, the system generates a set of image generation tokens corresponding to the set of groups respectively, where the synthetic image is generated based on the set of image generation tokens. In some cases, the operations of this step refer to, or may be performed by, a multimodal generation model as described with reference to FIGS. 9, 15, and 19. For example, these image generation tokens encode the visual attributes based on the corresponding groups, enabling the system to generate a synthetic image that balances both subject consistency and contextual adaptation. The synthetic image is generated based on a combination of these tokens, ensuring that the synthetic image accurately depicts the object in the input image while adapting to the specific variations described in the image generation prompt. By progressively refining the image representation through similarity-based grouping, the system enhances personalization, generalization, and visual coherence in multimodal generation tasks.

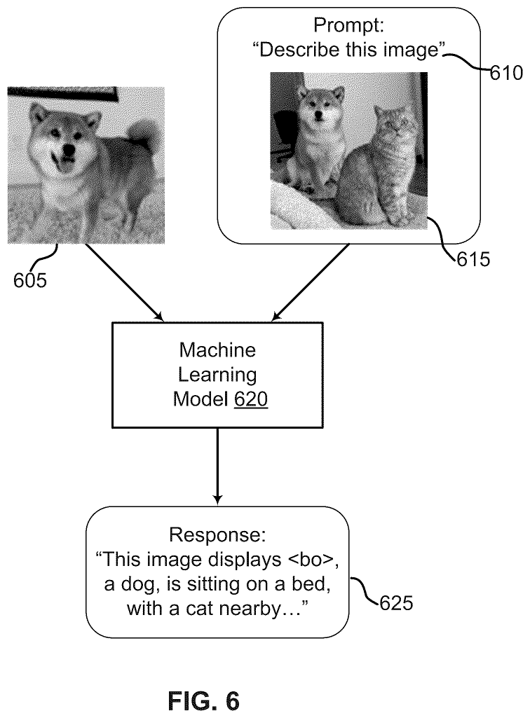

FIG. 6 shows an example of multimodal image question answering according to aspects of the present disclosure. The example shown includes multimodal generation system, input image 605, image understanding prompt 610, query image 615, machine learning model 620, and response 625. In some embodiments, the multimodal generation system is implemented in a user interface.

Referring to FIG. 6, multimodal generation system generates a response 625 based on the input image 605, image understanding prompt 610, and query image 615. For example, the input image 605 depicts a dog. The image understanding prompt 610 states “Describe this image,” and the query image 615 depicts a dog and a cat sitting on a bed.

In some embodiments, the machine learning model 620 receives input image 605, image understanding prompt 610, and query image 615 to generate a set of custom tokens including an image generation token and an image understanding token. In one embodiment, the machine learning model 620 identifies the task based on the image understanding prompt 610. For example, the machine learning model 620 may determine this is a visual question answering task. Then, the machine learning model 620 generates the response 625 that answers the image understanding prompt 610 based on the query image 615 and the image understanding token. For example, the response states “This image displays <bo>, a dog, is sitting on a bed, with a cat nearby . . . ” In one aspect, “<bo>” represents a nonce token that identifies the dog depicted in the input image 605.

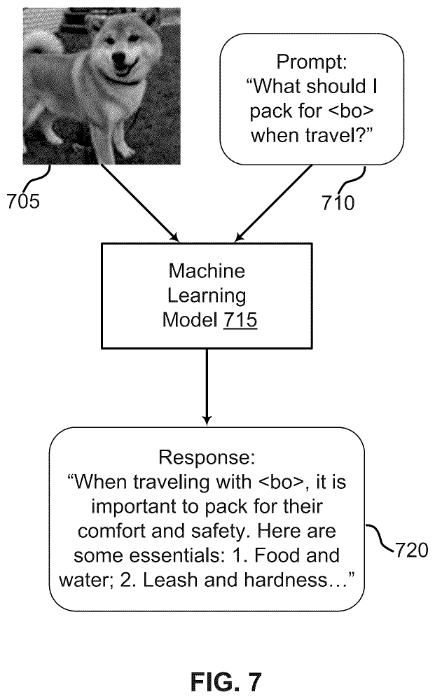

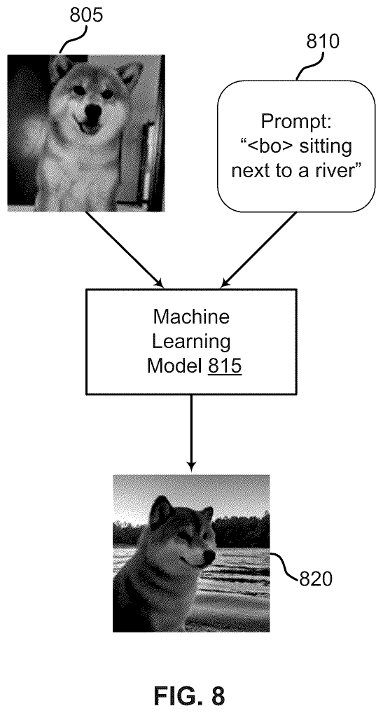

Multimodal generation system is an example of, or includes aspects of, the corresponding element described with reference to FIGS. 7 and 8. Input image 605 is an example of, or includes aspects of, the corresponding element described with reference to FIGS. 7-9. Image understanding prompt 610 is an example of, or includes aspects of, the corresponding element described with reference to FIG. 7.

Machine learning model 620 is an example of, or includes aspects of, the corresponding element described with reference to FIGS. 7 and 8. Response 625 is an example of, or includes aspects of, the corresponding element described with reference to FIGS. 7 and 9.

FIG. 7 shows an example of multimodal text generation according to aspects of the present disclosure. The example shown includes multimodal generation system, input image 705, image understanding prompt 710, machine learning model 715, and response 720. In some embodiments, the multimodal generation system is implemented in a user interface.

Referring to FIG. 7, multimodal generation system generates a response 720 based on the input image 705 and image understanding prompt 710. The input image 705 depicts a dog, and the image understanding prompt 710 states, “What should I pack for <bo> when travel?” The machine learning model 715 processes the input information to generate a personalized response (e.g., the response 720) regarding travel essentials for the subject depicted in the input image 705.

In some embodiments, the machine learning model 715 receives the input image 705 and image understanding prompt 710 to generate custom tokens including an image understanding token. The machine learning model 715 identifies the task as a language-based conversation and retrieves relevant contextual information. Based on the image understanding token, the machine learning model 715 generates response 720 that states “When traveling with <bo>, it is important to pack for their comfort and safety. Here are some essentials: 1. Food and water; 2. Leash and harness . . . ” In one aspect, “<bo>” represents a nonce token that uniquely identifies the dog from input image 705, ensuring that the response remains personalized to the depicted subject.

Multimodal generation system is an example of, or includes aspects of, the corresponding element described with reference to FIGS. 6 and 8. Input image 705 is an example of, or includes aspects of, the corresponding element described with reference to FIGS. 6, 8, and 9. Image understanding prompt 710 is an example of, or includes aspects of, the corresponding element described with reference to FIG. 6.

Machine learning model 715 is an example of, or includes aspects of, the corresponding element described with reference to FIGS. 6 and 8. Response 720 is an example of, or includes aspects of, the corresponding element described with reference to FIGS. 6 and 9.

FIG. 8 shows an example of multimodal image generation according to aspects of the present disclosure. The example shown includes multimodal generation system, input image 805, image generation prompt 810, machine learning model 815, and synthetic image 820. In some embodiments, the multimodal generation system is implemented in a user interface.

Referring to FIG. 8, multimodal generation system generates a synthetic image 820 based on the input image 805 and the image generation prompt 810. The input image 805 depicts a dog, and the prompt 810 describes a target variation that states “<bo> sitting next to a river.” The system processes the input image 805 and image generation prompt 810 to generate a personalized image (e.g., synthetic image 820) placing the identified subject in the specified context.

In some embodiments, the machine learning model 815 receives the input image 805 and image generation prompt 810 to generate custom tokens including an image generation token and an image understanding token. The model identifies the task as an image generation task and uses the image generation token to generate the synthetic image 820. Based on the custom tokens, the machine learning model 815 generates synthetic image 820 that depicts the same dog from input image 805 but positioned in a new scene (i.e., next to a river) described by image generation prompt 810. By using the image generation tokens, the multimodal generation system ensures that the identity and key visual features of the original subject (e.g., the dog) from the input image 805 are preserved, while allowing for contextual variation in the synthetic image 820 consistent with the description in the image generation prompt 810.

Multimodal generation system is an example of, or includes aspects of, the corresponding element described with reference to FIGS. 6 and 7. Input image 805 is an example of, or includes aspects of, the corresponding element described with reference to FIGS. 6, 7, and 9. Machine learning model 815 is an example of, or includes aspects of, the corresponding element described with reference to FIGS. 6 and 7. Synthetic image 820 is an example of, or includes aspects of, the corresponding element described with reference to FIG. 9.

### System Architecture

In FIGS. 7-13 and 19-20, an apparatus and system for multimodal generation include a memory component, a processing device coupled to the memory component, the processing device configured to perform operations comprising: obtaining an input image and an image generation prompt, wherein the input image depicts an object and the image generation prompt describes a different view of the object, generating a set of custom tokens based on the input image, wherein the set of custom tokens includes an image generation token and an image understanding token, and generating a synthetic image based on the image generation prompt and the image generation token, wherein the synthetic image depicts the variation of the object described by the image generation prompt and preserves an identity of the object from the input image.

Some examples of the apparatus and system further include obtaining an image understanding prompt comprising a question about the input image. Some examples further include generating, using the multimodal generation model, a response to the image understanding prompt based on the image understanding token, wherein the response includes an answer to the question.

In some aspects, the multimodal generation model includes a transformer model for performing an image understanding task. In some aspects, the multimodal generation model includes a diffusion model for performing an image generation task.

FIG. 9 shows an example of a machine learning model according to aspects of the present disclosure. The example shown includes machine learning system, prompt 905, input image 910, text tokenizer 915, text tokens 920, image tokenizer 925, image tokens 930, custom tokens 935, multimodal generation model 950, intermediate tokens 955, text de-tokenizer 960, image de-tokenizer 965, response 970, and synthetic image 975. In one aspect, custom tokens 935 includes image generation token 940 and image understanding token 945.

Referring to FIG. 9, the machine learning system receives a prompt 905 and an input image 910 to generate a response 970 and/or a synthetic image 975. For example, system converts the prompt 905 into text tokens 920 using a text tokenizer 915, and the input image 910 into image tokens 930 using an image tokenizer 925. These tokenized representations enable the multimodal generation model 950 to interpret and process multimodal inputs efficiently. Additionally, the system generates custom tokens 935, which include an image generation token 940 and an image understanding token 945, allowing for subject-specific personalization in both image and text generation tasks.

In one aspect, the text tokenizer 915 is a processing component that converts a textual prompt or input (e.g., prompt 905) into a structured representation (e.g., text tokens 920), which are the fundamental units used by a machine learning model to understand and generate text. In some cases, tokenization involves breaking down an input text (e.g., prompt 905) into smaller elements, such as words, sub-words, or characters, allowing the machine learning model (or multimodal generation model 950) to process and analyze natural language efficiently. In an embodiment, the text tokenizer transforms a prompt 905 (e.g., “Describe this image”) into a series of text tokens 920, which are then used by the multimodal generation model 950 to generate corresponding responses or guide image generation process. These text tokens 920 enable the multimodal generation model 950 to align language with other data modalities, such as images, audio, or video, ensuring that the generated output accurately reflects content described by the prompt 905.

In one aspect, image tokenizer 925 is a processing component that converts an input image 910 into a structured representation (e.g., image tokens 930), which encode the visual features for a machine learning model to interpret and generate images. The image tokenizer 925 extracts visual attributes or visual features such as color, shape, texture, and spatial relationships, transforming the image into a numerical format that the machine learning model (or multimodal generation model 950) can process. In an embodiment, these image tokens serve as the visual counterpart to text tokens, enabling the multimodal generation model 950 to understand images in conjunction with textual prompts (e.g., the prompt 905). For example, when the input image 910 depicts a dog, the image tokenizer 925 generates image tokens 930 that allow the multimodal generation model 950 to either describe the input image 910 in text or generate a synthetic image 975 with different views while preserving the identity of the object depicted in the input image (e.g., the dog).

In one aspect, the machine learning system is trained to generate custom tokens 935 based on the input image 910. In one aspect, the custom tokens 935 include an image generation token 940 and an image understanding token 945 that enable the multimodal generation model 950 to personalize outputs for both image generation and text-based tasks.

In one aspect, the image generation token 940 is trained to encode fine-grained visual details of an object depicted in the input image 910, allowing the system to generate new images while preserving the identity of the object. The image generation token 940 token captures key visual attributes such as shape, texture, and color, ensuring that synthetic images remain visually consistent with the original object while with variations.

In one aspect, the image understanding token 945 is trained to encode and store semantic and descriptive information about the object depicted in the input image 910, enabling the multimodal generation model 950 to answer questions or describe input image 910 accurately in response to a text-based prompt (e.g., prompt 905). The image understanding token 945 enables the model to retain subject-specific knowledge and to generate personalized textual responses when queried about the input image 910. Using the image generation token 940 and image understanding token 945 ensure that the multimodal generation model 950 can accurately balance image and text-based personalization.

The multimodal generation model 950 receives the text tokens 920, image tokens 930, and custom tokens 935 to generate intermediate tokens 955, which encode a structured representation of the input data. In some embodiments, the multimodal generation model 950 may include a large multimodal model (LMM). An LMM is a type of machine learning model configured to process and generate content based on multiple modalities, such as text, images, and code, within a unified model. Unlike conventional multimodal systems that rely on separate encoders and decoders for different modalities, LMMs use a token-based early-fusion approach. For example, both text and images are converted into discrete tokens and processed within the same transformer-based architecture. By training on vast amounts of interleaved mixed-modal data, LMMs can integrate, understand, and generate content that blends different forms or types of information or data (e.g., text, image, audio, or video).

LMMs work by representing all input data as tokens within a shared embedding space. Images are tokenized using a learned codebook, similar to how words are tokenized in natural language processing. This uniform representation enables the machine learning model to apply the same transformer architecture to both text and images without separate modality-specific components. LMMs are trained in an autoregressive manner, predicting the next token in a sequence based on the preceding tokens, whether the tokens represent text or image data. During inference, the model can generate multimodal outputs, such as answering questions about images, generating interleaved text-image documents, or generating visual content based on textual descriptions.

In some aspects, the LMMs include a transformer architecture. A transformer is a deep learning architecture designed for processing sequential data, primarily used in natural language processing (NLP) and multimodal machine learning models. The transformer includes a self-attention mechanism that enables parallel processing of entire input sequences, and thus improving efficiency and scalability. The core of the transformer consists of multiple layers of self-attention and feed-forward networks, enabling the transformer to capture long-range dependencies and contextual relationships between tokens. Transformers use positional encodings to retain order information, and mechanisms like multi-head attention enable the model to focus on different parts of an input simultaneously.

These intermediate tokens 955 are then passed provided to a text de-tokenizer 960 to generate a response 970 or an image de-tokenizer 965 to generate a synthetic image 975 based on the task described in prompt 905. For example, when the task specifies text-based understanding, the multimodal generation model 950 uses the image understanding token 945 to ensure that the model accurately describes or answers questions about the subject in the input image 910. When the task describes image synthesis, the multimodal generation model 950 uses the image generation token 940 to generate a synthetic image 975 that preserves the visual identity of the object having a different view described by the prompt 905. Accordingly, the token-based approach enhances multimodal personalization, ensuring that the machine learning system can generate coherent, high-quality outputs across both text and image modalities.

According to some embodiments, the machine learning system receives a limited number of input images depicting an object, where the input images are denoted as I¹, I², . . . , Iⁿ (typically 3-5 images), and train the multimodal generation model 950 to embed the object into a special token (e.g., <sks>) (or a nonce token) and to perform personalized language generation (e.g., “Describe <sks>”; or given an image, “Where is <sks> in this image?”) and personalized vision generation (e.g., “Generate a photo of <sks>”)

According to some embodiments, the machine learning system encodes the prompt 905 and input image 910 into a custom token architecture:
“<sks> is <token₁> <token₂> . . . <tokenₖ>.”
   where <sks> is a learnable unique identifier for the object, and <tokenᵢ> corresponds to the learnable tokens that encode visual information of the concept. Accordingly, the system can increase the computational efficiency by requiring updates to a small subset of parameters (i.e., tokens) while preserving the original core model weights.

According to some embodiments, the system generates two series of learnable tokens, each dedicated to a specific task. Specifically, the personalized concepts are represented as:
“<sks> is <g-tokens> <u-tokens>.”

where <g-tokens> and <u-tokens> represent k and h learnable tokens for image generation and understanding, respectively. In some cases, these tokens not only serve as task-mode calling tokens (i.e., for image generation or text generation) but also function as latent tokens, which contains the information needed to perform the task.

Input image 910 is an example of, or includes aspects of, the corresponding element described with reference to FIGS. 6-8. Text tokenizer 915 is an example of, or includes aspects of, the corresponding element described with reference to FIG. 15. Text tokens 920 is an example of, or includes aspects of, the corresponding element described with reference to FIG. 15.

Image tokenizer 925 is an example of, or includes aspects of, the corresponding element described with reference to FIG. 15. Custom tokens 935 is an example of, or includes aspects of, the corresponding element described with reference to FIG. 16. Image generation token 940 is an example of, or includes aspects of, the corresponding element described with reference to FIG. 15. Image understanding token 945 is an example of, or includes aspects of, the corresponding element described with reference to FIG. 15.

Multimodal generation model 950 is an example of, or includes aspects of, the corresponding element described with reference to FIGS. 15 and 19. Response 970 is an example of, or includes aspects of, the corresponding element described with reference to FIGS. 6 and 7. Synthetic image 975 is an example of, or includes aspects of, the corresponding element described with reference to FIG. 8.

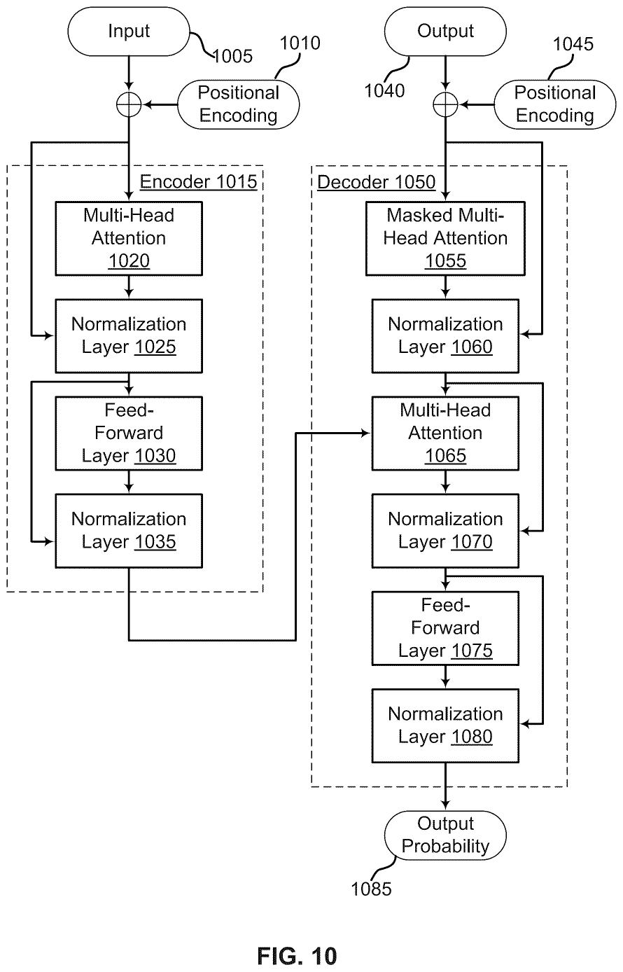

FIG. 10 shows an example of a transformer architecture according to aspects of the present disclosure. The example shown includes transformer architecture, input 1005, positional encoding 1010, encoder 1015, multi-head attention 1020, normalization layer 1025, feed-forward layer 1030, normalization layer 1035, output 1040, positional encoding 1045, decoder 1050, masked multi-head attention 1055, normalization layer 1060, multi-head attention 1065, normalization layer 1070, feed-forward layer 1075, normalization layer 1080, and output probability 1085. The transformer architecture is an example of, or includes aspects of, the multimodal generation model described with reference to FIGS. 9, 15, and 19.

Referring to FIG. 10, the transformer architecture is a type of deep learning model trained and configured for processing sequential data, particularly in natural language processing tasks. In some embodiments, the transformer architecture includes an encoder-decoder structure configured to handle complex dependencies in data without relying on recurrence.

The process begins with input 1005 representing the tokenized text, sequence, or tokenized image to be processed. Since transformers do not inherently maintain order, positional encoding 1010 is added to the input embeddings of the input 1005 to retain sequential information. The data is then provided into the encoder 1015 for capturing contextual relationships between the tokens. In one aspect, the encoder 1015 includes multi-head attention 1020, normalization layer 1025, feed-forward layer 1030, and normalization layer 1035. The multi-head attention 1020 enables the model to focus on multiple aspects of the input sequence simultaneously to capture different contextual meanings. The normalization layer 1025 ensures that gradients remain stable during training, while the feed-forward layer 1030 processes each token independently to refine the representation. In some cases, feed-forward layer 1030 applies non-linear transformations to enhance the feature representation. Then, normalization layer 1035 is applied before the intermediate representation is provided to the decoder. In some cases, the intermediate representation represents the processed and stabilized token representations after undergoing self-attention and feed-forward transformations in the encoder 1015. In an embodiment, the normalization layer 1025 and normalization layer 1035 may apply the same mathematical operation (e.g., LayerNorm) to the output of multi-head attention 1020 and feed-forward layer 1030, respectively.

Then, output 1040 is used to transform the target sequence into vector representations, and positional encoding 1045 is again added to retain the sequence order. The decoder 1050 follows a structure similar to the encoder 1015 but includes an additional masked multi-head attention 1055 layer. In one aspect, the decoder 1050 includes masked multi-head attention 1055, normalization layer 1060, multi-head attention 1065, normalization layer 1070, feed-forward layer 1075, and normalization layer 1080. This masking ensures that during training, the model does not access future tokens, enforcing an autoregressive property. Normalization layer 1060 stabilizes the learning process before the multi-head attention 1065 layer, which enables the decoder 1050 to focus on relevant parts of the encoded input sequence (e.g., the intermediate representation from the normalization layer 1035). Normalization layer 1070 ensures smooth learning, followed by the feed-forward layer 1075, which processes each contextual representation of the token independently. The normalization layer 1080 further refines the representation.

The final output is computed through a linear transformation and passed to the output probability layer, where a softmax function assigns probabilities (e.g., output probability 1085) to each possible next token in the sequence. This enables the model to generate meaningful and coherent text based on the given input (e.g., input 1005).

In the field of image generation or multimodal generation, the transformer model processes and aligns information from the text and image modalities to generate an output. For example, the model encodes the text and image. The text prompt is tokenized, embedded, and passed through a transformer-based text encoder, where positional encoding is added to retain word order. Simultaneously, the image input is divided into patches, each converted into embeddings using an image encoder. Positional encoding is applied to preserve spatial structure, and the image encoder processes the image patches into a latent representation. Then, the multimodal transformer aligns the text tokens and the image patches using cross-attention mechanisms allowing text and image representations to interact in a shared multimodal embedding space. By doing so, the model can accurately reflect the output to retain the semantic meaning of the text prompt and image guidance from the input image.

After the text and image representations are aligned, the combined representation are passed to a text decoder or image decoder, which decodes the latent features into an output response or output image, respectively. Text decoder is an example of, or includes aspects of, the text de-tokenizer described with reference to FIG. 9. Image decoder is an example of, or includes aspects of, the image de-tokenizer described with reference to FIG. 9.

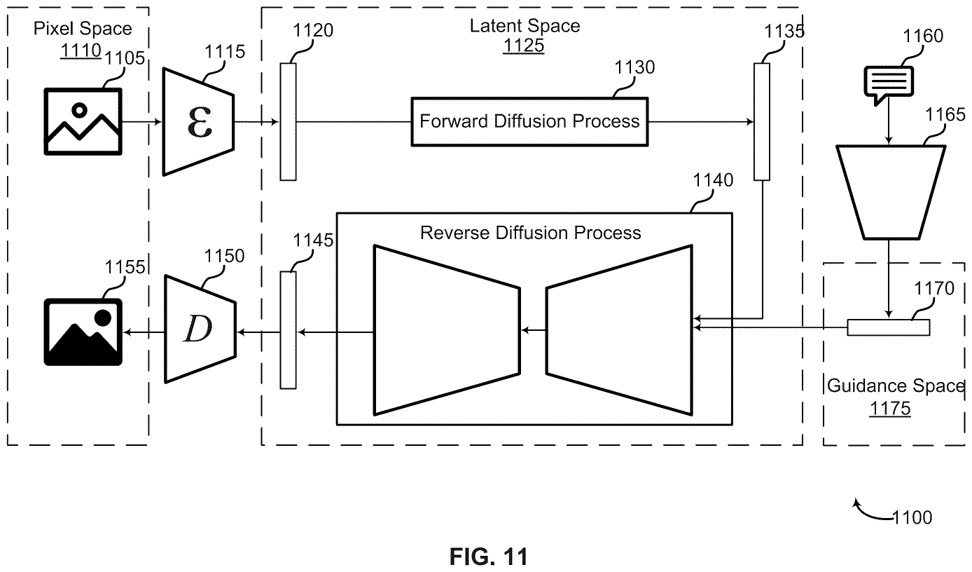

FIG. 11 shows an example of an image generation model according to aspects of the present disclosure. The example shown includes diffusion model, original image 1105, pixel space 1110, image encoder 1115, original image feature 1120, latent space 1125, forward diffusion process 1130, noisy feature 1135, reverse diffusion process 1140, denoised image feature 1145, image decoder 1150, output image 1155, text prompt 1160, text encoder 1165, guidance feature 1170, and guidance space 1175. According to some embodiments, the multimodal generation model 950 described with reference to FIG. 9 includes a diffusion model described herein.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model may take an original image 1105 in a pixel space 1110 as input and apply an image encoder 1115 to convert original image 1105 into original image feature 1120 in a latent space 1125. Then, a forward diffusion process 1130 gradually adds noise to the original image feature 1120 to obtain noisy feature 1135 (also in latent space 1125) at various noise levels.

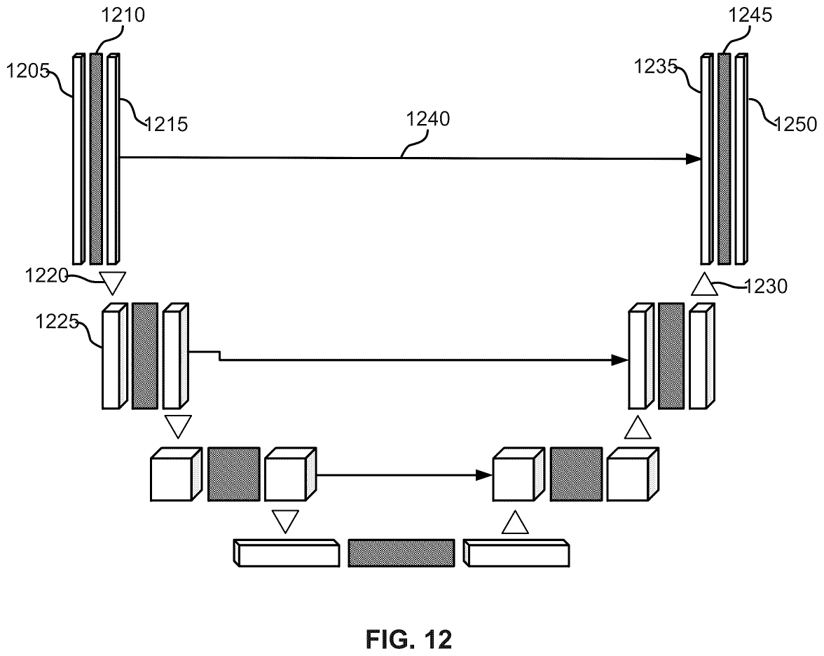

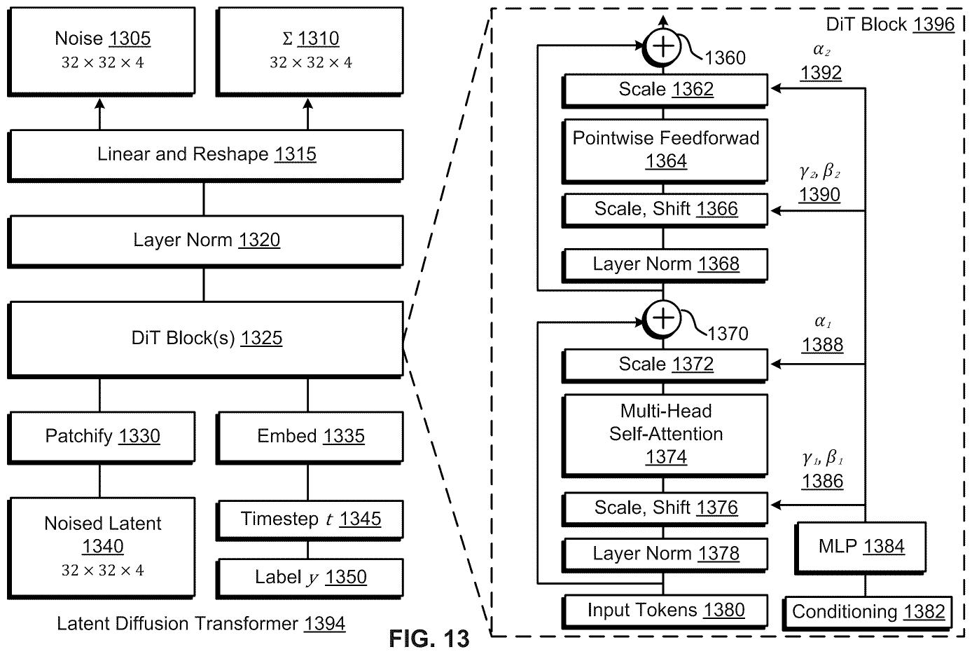

Next, a reverse diffusion process 1140 (e.g., a U-Net ANN) gradually removes the noise from the noisy feature 1135 at the various noise levels to obtain the denoised image feature 1145 in latent space 1125. In some examples, denoised image feature 1145 is compared to the original image feature 1120 at each of the various noise levels, and parameters of the reverse diffusion process 1140 of the diffusion model are updated based on the comparison. Then, an image decoder 1150 decodes the denoised image feature 1145 to obtain an output image 1155 in pixel space 1110. In some cases, an output image 1155 is created at each of the various noise levels. The output image 1155 can be compared to the original image 1105 to train the reverse diffusion process 1140. In some cases, output image 1155 refers to the synthetic image (e.g., described with reference to FIG. 8-9). In an embodiment, the reverse diffusion process 1140 may be performed using a U-Net architecture described with reference to FIG. 12. In an embodiment, the reverse diffusion process 1140 may be performed using a diffusion transformer (DiT) architecture described with reference to FIG. 13.

In some cases, image encoder 1115 and image decoder 1150 are pre-trained prior to training the reverse diffusion process 1140. In some examples, image encoder 1115 and image decoder 1150 are trained jointly, or the image encoder 1115 and image decoder 1150 are fine-tuned jointly with the reverse diffusion process 1140.

The reverse diffusion process 1140 can also be guided based on a text prompt 1160, or another guidance prompt, such as an image, a layout, a style, a color, a segmentation map, etc. The text prompt 1160 can be encoded using a text encoder 1165 (e.g., a multimodal encoder) to obtain guidance feature 1170 in guidance space 1175. The guidance feature 1170 can be combined with the noisy feature 1135 at one or more layers of the reverse diffusion process 1140 to ensure that the output image 1155 includes content described by the text prompt 1160. For example, guidance feature 1170 can be combined with the noisy feature 1135 using a cross-attention block within the reverse diffusion process 1140. In some cases, the guidance space 1175 refers to the guidance embedding space.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features. Further detail on the U-Net is described with reference to FIG. 12.

A diffusion process may also be modified based on conditional guidance. In some cases, a user provides a text prompt (e.g., text prompt 1160) describing content to be included in a generated image. In some examples, guidance can be provided in a form other than text, such as via an image, a sketch, a color, a style, or a layout. The system converts text prompt 1160 (and/or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model generates an image based on the noise map and the conditional guidance vector.

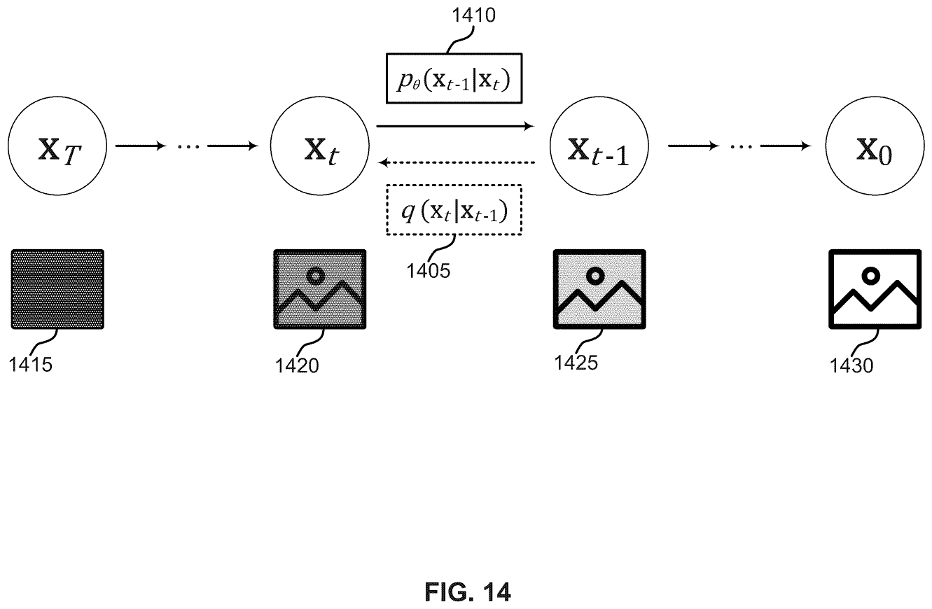

A diffusion process can include both a forward diffusion process 1130 for adding noise to an image (e.g., original image 1105) or features (e.g., original image feature 1120) in a latent space 1125 and a reverse diffusion process 1140 for denoising the images (or features) to obtain a denoised image (e.g., output image 1155). The forward diffusion process 1130 can be represented as q(xₜ|xₜ₋₁), and the reverse diffusion process 1140 can be represented as p_{θ}(xₜ₋₁|xₜ). Further detail on the diffusion process is described with reference to FIG. 14.

A diffusion model may be trained using both a forward diffusion process 1130 and a reverse diffusion process 1140. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 1130 in N stages. In some cases, the forward diffusion process 1130 is a fixed process where Gaussian noise is successively added to an image. In latent diffusion models, the Gaussian noise may be successively added to features (e.g., original image feature 1120) in a latent space 1125.

At each stage n, starting with stage N, a reverse diffusion process 1140 is used to predict the image or image features at stage n−1. For example, the reverse diffusion process 1140 can predict the noise that was added by the forward diffusion process 1130, and the predicted noise can be removed from the image to obtain the predicted image. In some cases, an original image 1105 is predicted at each stage of the training process.

The training component (e.g., training component described with reference to FIG. 19) compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data. The training component then updates parameters of the diffusion model based on the comparison. For example, parameters of a U-Net may be updated using gradient descent. Time-dependent parameters of the Gaussian transitions can also be learned. Further detail on training the diffusion model is described with reference to FIG. 18.

Original image 1105 is an example of, or includes aspects of, the corresponding element described with reference to FIG. 14. Forward diffusion process 1130 is an example of, or includes aspects of, the corresponding element described with reference to FIG. 14. Reverse diffusion process 1140 is an example of, or includes aspects of, the corresponding element described with reference to FIG. 14.

FIG. 12 shows an example of a U-Net architecture according to aspects of the present disclosure. The example shown includes U-Net, input feature 1205, initial neural network layer 1210, intermediate feature 1215, down-sampling layer 1220, down-sampled feature 1225, up-sampling process 1230, up-sampled feature 1235, skip connection 1240, final neural network layer 1245, and output feature 1250.

In some examples, U-Net is an example of the component that performs the reverse diffusion process 1140 of diffusion model described with reference to FIG. 11 and includes architectural elements of the multimodal generation model 950 described with reference to FIG. 9. The U-Net depicted in FIG. 12 is an example of, or includes aspects of, the architecture used within the reverse diffusion process described with reference to FIG. 11.

In some examples, diffusion models are based on a neural network architecture known as a U-Net. The U-Net takes input feature 1205 having an initial resolution and an initial number of channels, and processes the input feature 1205 using an initial neural network layer 1210 (e.g., a convolutional network layer) to produce intermediate feature 1215. The intermediate feature 1215 is then down-sampled using a down-sampling layer 1220 such that the down-sampled feature 1225 has a resolution less than the initial resolution and a number of channels greater than the initial number of channels.

This process is repeated multiple times, and then the process is reversed. For example, the down-sampled feature 1225 is up-sampled using up-sampling process 1230 to obtain up-sampled feature 1235. The up-sampled feature 1235 can be combined with intermediate feature 1215 having the same resolution and number of channels via a skip connection 1240. These inputs are processed using a final neural network layer 1245 to produce output feature 1250. In some cases, the output feature 1250 has the same resolution as the initial resolution and the same number of channels as the initial number of channels.

In some cases, U-Net takes an additional input feature to produce conditionally generated output. For example, the additional input feature could include a vector representation of an input prompt. The additional input feature can be combined with the intermediate feature 1215 within the neural network at one or more layers. For example, a cross-attention module can be used to combine the additional input features and the intermediate feature 1215.

FIG. 13 shows an example of a diffusion transformer model according to aspects of the present disclosure. The example shown includes predicted noise 1305, predicted covariance 1310, linear and reshape layers 1315, normalization layer 1320, DiT block(s) 1325, patchify operation 1330, embedding 1335, noised latent 1340, timestep information 1345, label information 1350, and an implementation of one block in the DiT block(s) 1325 by a DiT Block 1396. In one aspect, the DiT Block 1396 includes second residual connection 1360, second scaling operations 1362, feed-forward network 1364, post-normalization second scaling and shifting 1366, second normalization 1368, first residual connection 1370, first scaling operations 1372, self-attention 1374, post-normalization first scaling and shifting 1376, first normalization 1378, input tokens 1380, conditioning tokens 1382, multi-layer perceptron (MLP) 1384, post-normalization first scaling and shifting parameters 1386, first scaling parameter 1388, post-normalization second scaling and shifting parameters 1390, and second scaling parameter 1392. In some embodiments, the architecture uses a Latent Diffusion Transformer 1394. In some embodiments, DiT Block 1396 uses an “adaLN-Zero” technique.

Diffusion Transformers (DiTs) is a popular architecture for diffusion models and is designed to be structurally faithful to standard transformer architecture. DiT incorporates the scaling properties of the transformer structures. For training denoising diffusion probabilistic models (DDPMs) of images (e.g., spatial representations of images), DiT is based on a Vision Transformer (ViT) architecture which operates on sequences of patches. DiT processes images by dividing the images into patches, converting these patches into tokens, and applying attention mechanisms to model relationships between different regions of the image. This approach enables the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p will quadruple T, which in some cases at least quadruples total of transformer Giga Floating Point Operations (Gflops). In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x [symbol] x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all as; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks, large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The diffusion transformer model, in some cases, employs a Latent Diffusion Transformer 1394. The diffusion transformer model processes noised latent 1340, which may be a noised version of an input image encoded in a latent space. Patchify operation 1330 divides the noised latent into a sequence of patches that are processed as tokens. The tokens are vector representations of each patch of the image in latent space, and are adjusted through attention processes. Each of the tokens also receives timestep information 1345 and label information 1350 and the embedding 1335 encodes the current denoising timestep and class labels as conditional information. In some cases, embedding 1335 is referred to as conditional embedding or conditional information embedding. In some cases, a positional embedding which encodes each token's spatial position in the image is applied to the patchified input tokens at the patchify operation 1330. In some examples the positional embedding is ViT frequency-based positional embedding. The input tokens 1380 generated by the patchify operation 1330 and the conditioning tokens 1382 generated by the embedding 1335 are processed through N DiT block(s) 1325, where N may be 132, 24 or 28. Other values of N may be used. In some cases, conditional tokens refer to tokens generated based on embedding 1335 encoding timestep information 1345 and label information 1350.

Each of the DiT block(s) 1325 includes multiple processing stages. DiT Block 1396 illustrates an embodiment of one block in the DiT block(s) 1325. In some embodiments, the DiT Block 1396 is an example of, or includes aspects of, the adaLN-Zero block. In some cases, input tokens 1380 interact with the conditioning tokens 1382 through multiple attention mechanisms. Particularly, after first normalization 1378 applied to the input tokens and MLP 1384 to the conditional tokens, MLP 1384 generates or updates post-normalization first scaling and shifting parameters 1386, denoted as γ₁, β₁, for post-normalization first scaling and shifting 1376 to scale and shift the output of first normalization 1378 accordingly. As the normalized input tokens obtained from first normalization 1378 are scaled and shifted at post-normalization first scaling and shifting 1376 using the conditional information carried as least in γ₁, β₁, this allows the input information and conditional information to interact. Self-attention 1374 allows the scaled and shifted normalized input tokens, namely the output from post-normalization first scaling and shifting 1376, to attend to each other. MLP 1384 also generates or updates first scaling parameter 1388 denoted as α₁ for first scaling operations 1372 to scale the output of self-attention 1374 (e.g., multi-head self-attention), further interacting the input information and conditional information. The input tokens 1380 is then summed with the output of first scaling operations 1372 at first residual connection 1370. In some examples, α₁ has initial values 0, and the DiT Block 1396 is initialized as the identity function.

A similar process is performed in a second half of the DiT Block 1396. MLP 1384 generates or updates post-normalization second scaling and shifting parameters 1390, denoted as γ₂, β₂, for post-normalization second scaling and shifting 1366 to scale and shift the output of second normalization 1368 accordingly. As the output from second normalization 1368 is scaled and shifted using the conditional information carried at least in γ₂, β₂, this allows the input information and conditional information to further interact. Feed-forward network 1364 then processes the scaled and shifted output from post-normalization second scaling and shifting 1366. MLP 1384 also generates or updates second scaling parameter 1392 denoted as α₂ for second scaling operations 1362 to scale the output of feed-forward network 1364, further interacting the input information and conditional information. In some cases, the feed-forward network 1364 is a pointwise feed-forward network. The output from first residual connection 1370 is then summed with the output of second scaling operations 1362 at second residual connection 1360, and the result is the final output of DiT Block 1396. In some examples, α₂ has initial values 0, and the DiT Block 1396 is initialized as the identity function. This process repeats for each DiT block in the sequence.

After processing through all DiT block(s) 1325, the outputs undergo normalization layer 1320 followed by linear and reshape layers 1315. The final output is the predicted noise 1305, which represents the model's prediction of the noise that was added to initially create the noised latent 1340, and the predicted covariance 1310, which represents the model's prediction of the covariance. The predicted noise 1305 is removed from noised latent 1340 at each diffusion timestep, and the predicted covariance may affect how noise is removed or resampled in the reverse or denoising process. At the end of the denoising schedule, the latent sample is decoded to generate the synthetic image in pixel space.

### Diffusion Process

FIG. 14 shows an example of a diffusion process according to aspects of the present disclosure. The example shown includes diffusion process, forward diffusion process 1405, reverse diffusion process 1410, noisy image 1415, first intermediate image 1420, second intermediate image 1425, and original image 1430.

Diffusion process can include forward diffusion process 1405 for adding noise to original image 1430 (e.g., original image 1105 described with reference to FIG. 11) or features (e.g., original image feature 1120 described with reference to FIG. 11) in a latent space. In some aspects, diffusion process includes reverse diffusion process 1410 for denoising the noisy image 1415 (or image features) to obtain a denoised image (or original image 1430). The forward diffusion process 1405 can be represented as q(xₜ|xₜ₋₁), and the reverse diffusion process 1410 can be represented as p_{θ}(xₜ₋₁|xₜ). In some cases, the forward diffusion process 1405 is used during training to generate images with successively greater noise, and a neural network is trained to perform the reverse diffusion process 1410 (e.g., to successively remove the noise).

In an example forward diffusion process 1405 for a latent diffusion model (e.g., diffusion model 1000 described with reference to FIG. 10), the diffusion model maps an observed variable x₀ (either in a pixel space or a latent space) to obtain intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x₇ have the same dimensionality as x₀.

The neural network may be trained to perform the reverse diffusion process 1410. During the reverse diffusion process 1410, the diffusion model begins with noisy data x_{T}, such as a noisy image 1415 and denoises the data to obtain the p_{θ}(xₜ₋₁|xₜ). At each step t−1, the reverse diffusion process 1410 takes xₜ, such as the first intermediate image 1420, and t as input. Here, t represents a step in the sequence of transitions associated with different noise levels, The reverse diffusion process 1410 outputs xₜ₋₁, such as the second intermediate image 1425, iteratively until x_{T} is reverted back to x₀, the original image 1430. The reverse diffusion process 1410 can be represented as:

p_{θ}(xₜ₋₁|xₜ):=N(xₜ₋₁;μ_{θ}(xₜ,t),Σ_{θ}(xₜ,t). (1)

The joint probability of a sequence of samples in the Markov chain can be written as a product of conditionals and the marginal probability:

$${x}_{T} : {p}_{θ} ( {x}_{0 : T} ) : = p ( {x}_{T} ) {Π}_{t = 1}^{T} {p}_{θ} ( {x}_{t - 1} \vert {x}_{t} ) , \qquad ( 2 )$$

where p(x_{T})=N(x_{T}; 0, I) is the pure noise distribution as the reverse diffusion process 1410 takes the outcome of the forward diffusion process 1405, a sample of pure noise, as input and

$${Π}_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

Forward diffusion process 1405 is an example of, or includes aspects of, the corresponding element described with reference to FIG. 11. Reverse diffusion process 1410 is an example of, or includes aspects of, the corresponding element described with reference to FIG. 11. Original image 1430 is an example of, or includes aspects of, the corresponding element described with reference to FIG. 11.

### Training and Evaluation

In FIGS. 15-18, a method, apparatus, non-transitory computer readable medium, and system for training multimodal generation include training the multimodal generation model to select from among an image generation task and an image understanding task. In some aspects, the multimodal generation model is trained to perform an image generation task based on the image generation token and to perform an image understanding task based on the image understanding token. In some aspects, the image generation token is based on an image reconstruction loss.

FIG. 15 shows an example of image token reconstruction according to aspects of the present disclosure. The example shown includes training system, input 1505, text tokenizer 1510, text tokens 1515, multimodal generation model 1535, predicted image tokens 1540, training image 1545, image tokenizer 1550, ground-truth image tokens 1555, and image reconstruction loss 1560. In one aspect, text tokens 1515 includes nonce token 1520, image generation token 1525, and image understanding token 1530.

Referring to FIG. 15, training system trains the multimodal generation model 1535 to generate predicted image tokens 1540 (e.g., the image generation tokens described with reference to FIG. 9) based on the image reconstruction loss 1560. For example, a text tokenizer 1510 receives an input 1505 to generate text tokens 1515. In one aspect, the text tokens 1515 include a nonce token 1520, an image generation token 1525, and an image understanding token 1530. These tokens encode key information about the subject and guide the multimodal generation model 1535 in generating an accurate predicted image representation (e.g., predicted image tokens 1540) that aligns with the characteristics of the input 1505.

In one aspect, the training image 1545 is provided to an image tokenizer 1550 to generate ground-truth image tokens 1555. Then, the system compares the predicted image tokens 1540 with the ground-truth image tokens 1555 to generate an image reconstruction loss 1560. By minimizing this loss, the model refines the image generation token 1525, ensuring that synthesized images retain fine-grained visual details while maintaining subject identity. In one aspect, the image reconstruction loss 1560 is used to update the multimodal generation model 1535.

According to some embodiments, an image (e.g., training image 1445) is segmented into a series of image tokens, which are enclosed by special tokens indicating the start-of-image <soi> and the end-of-image <eoi>. The training objective for both image and text remains consistent with standard autoregressive modeling, where the model is trained to predict the next token in the sequence based on the previous tokens. Thus, training for personalization adheres to an instruction-tuning paradigm, where the loss computation is specifically focused on the response portion of the instruction-response pairs. Given the conversation pair

$$( {X}_{q}^{i} , {X}_{a}^{i} ) ,$$

where

$${X}_{q}^{i}$$

is the question, and

$${X}_{a}^{i}$$

is the corresponding answer, the masked language modeling loss for each conversation of length L by:

$$p ( {X}_{a} ) = {Π}_{j = 1}^{L} {p}_{θ} ( {x}_{j} \vert {X}_{a ′ < j} ) \qquad ( 3 )$$

where X_{a′>j} are the instruction and answer tokens in all turns before the current prediction token xⱼ. θ represents the trainable parameters, which, in this case, includes the concept identifier <sks>, k latent tokens, and the final classifier head matrix W of the language model that associated with these tokens.

Training system is an example of, or includes aspects of, the corresponding element described with reference to FIG. 16. Text tokenizer 1510 is an example of, or includes aspects of, the corresponding element described with reference to FIG. 9. Text tokens 1515 is an example of, or includes aspects of, the corresponding element described with reference to FIG. 9.

Nonce token 1520 is an example of, or includes aspects of, the corresponding element described with reference to FIG. 16. Image generation token 1525 is an example of, or includes aspects of, the corresponding element described with reference to FIG. 9.

Image understanding token 1530 is an example of, or includes aspects of, the corresponding element described with reference to FIG. 9. Multimodal generation model 1535 is an example of, or includes aspects of, the corresponding element described with reference to FIGS. 9 and 19. Image tokenizer 1550 is an example of, or includes aspects of, the corresponding element described with reference to FIG. 9.

FIG. 16 shows an example of learning image generation tokens according to aspects of the present disclosure. The example shown includes training system, custom tokens 1605, retrieved images 1625, and input images 1640. In one aspect, custom tokens 1605 includes nonce token 1610, first image generation token 1615, and second image generation token 1620. In one aspect, retrieved images 1625 includes first images 1630 and second images 1635.

Referring to FIG. 16, the training system trains the multimodal generation system to generate custom tokens 1605 using a soft positive approach. For example, the soft-positive training process is illustrated within training system, where custom tokens 1605 are used to retrieve and rank similar images based on the corresponding visual relevance to an object depicted in input images 1640. In one aspect, the training system generates custom tokens 1605 including a nonce token 1610, a first image generation token 1615, and a second image generation token 1620, which encode subject-specific visual features. These custom tokens 1605 is compared to retrieved images 1625, which are grouped into first images 1630 (less similar examples with fewer details) and second images 1635 (more visually similar examples with more details).

For example, the retrieved images 1625 are then compared against the input images 1640 to generate a similarity score. The similarity score is a numerical value that quantifies the degree of resemblance between two images based on the visual features such as shape, color, texture, and structural attributes. Then, the training system ranks the images based on the corresponding closeness to the attributes of the object depicted in input images 1640, such as texture, shape, and color patterns. By incorporating a soft-positive learning approach, the system assigns longer prompt embeddings (e.g., the second image generation token) to images that share higher similarity scores, allowing for a progressive refinement of object representation. This prevents overfitting while improving the generalization of the model, ensuring that personalized image generation maintains high fidelity to the object while enabling for contextual variations.

According to some embodiments, the training system trains a soft prompt on a limited set of n positive images. For example, the retrieved images 1625 are used as “soft positive” images. These images share varying degrees of similar characteristics with the positive samples (e.g., input images 1640), and thus should contribute differently to the learning process. For example, considering a pet (e.g., a Shiba Inu), each of the retrieved images 1625 may be referred to as a “soft positive” to varying extents. The similarity ranges from less to more similar images. For example, “A dog” (least similar), followed by “A dog with a yellow coat” (more similar), and so on.

In some cases, given N retrieved images 1625, these images are ranked from most to least similar to the average feature of the positive samples, based on CLIP image similarity score (e.g., similarity score). The ranked images are then divided into k−1 groups, each containing N/(k−1) images, based on the ranking. During training, an adaptive token allocation method is implemented. For example, retrieved images 1625 with higher similarity scores are assigned more learnable tokens (e.g., second image generation token 1620), enabling a more detailed representation of relevant features, and retrieved images 1625 with lower similarity scores are assigned fewer learnable tokens (e.g., first image generation token 1615). In some aspects, the set of tokens is used to encode the true positive images <sks> (e.g., the input images 1640), ensuring that the model maintains the ability to distinguish the target concept while leveraging relevant features from similar soft positive examples.

According to some embodiments, the training systems trains the multimodal generation model to generate image understanding tokens. For example, the training system generates a training dataset, which includes recognition data and question-answering data. For recognition data, a dataset including a number of positive examples alongside both 100 easy negative examples and 100 hard negative examples. For question-answering, which includes 10 questions (e.g., “What type of object is <sks>?”). A language generation model may be used to generate answers for these questions using the positive images.

During training, to ensure the model to learn the distinct roles of the two sets of tokens, the training data is designed such that the model first predicts which set of tokens (<g-tokens> vs. <u-tokens>) is to be used for the task. This process is referred to as “self-prompting” as the model needs to prompt itself first. For example, for text understanding tasks (e.g., “What kind of object is <sks>?”), the target output first includes <u-tokens>, followed by the actual answer. The same technique is applied for image generation tasks. By prompting the model to first predict the appropriate token set, the disclosed method enforces alignment of the corresponding tokens with each task.

Training system is an example of, or includes aspects of, the corresponding element described with reference to FIG. 15. Custom tokens 1605 is an example of, or includes aspects of, the corresponding element described with reference to FIG. 9. Nonce token 1610 is an example of, or includes aspects of, the corresponding element described with reference to FIG. 15.

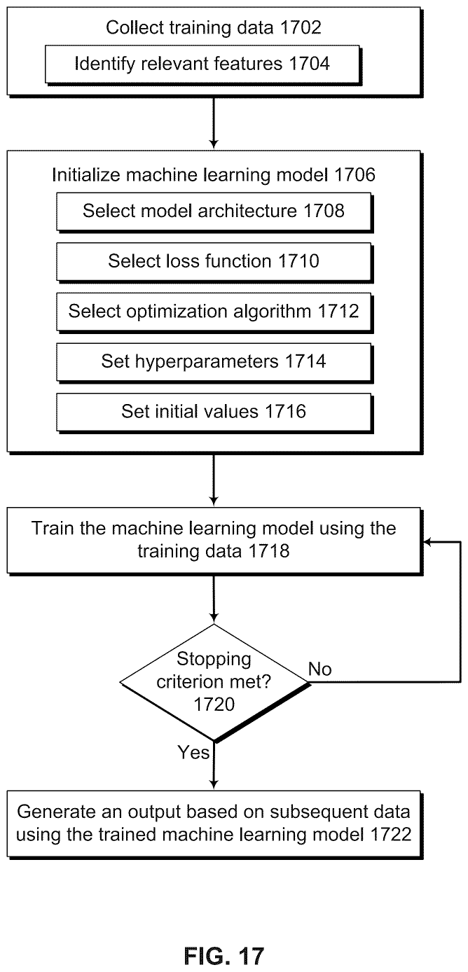

FIG. 17 shows an example of a flow diagram depicting an algorithm as a step-by-step procedure in an example implementation of operations performable for training a machine learning model according to aspects of the present disclosure. In some embodiments, the procedure describes an operation of the training component described for training the multimodal generation model 1920 as described with reference to FIG. 19. The procedure provides one or more examples of generating training data, use of the training data to train a machine-learning model, and use of the trained machine-learning model to perform a task

To begin in this example, a machine-learning system collects training data (block 1702) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1704) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1706). Initialization of the machine-learning model includes selecting a model architecture (block 1708) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1710). The loss function is utilized to measure a difference between an output of the machine-learning model (e.g., the model predictions) and target values (e.g., as expressed by the training data) to be used to train the machine-learning model. Additionally, an optimization algorithm is selected (block 1712) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1716) examples of which include initializing weights and biases of nodes to increase efficiency in training and computational resources consumption as part of training. Hyperparameters are also set (block 1714) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1718) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1720), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1720), procedure continues the training of the machine-learning model using the training data (block 1718) in this example.

If the stopping criterion is met (“yes” from decision block 1720), the trained machine-learning model is then utilized to generate an output based on subsequent data (block 1722). The trained machine-learning model, for instance, is trained to perform a task as described above and therefore, once trained is configured to perform that task based on subsequent data received as an input and processed by the machine-learning model.

FIG. 18 shows an example of a method for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

In some embodiments, the method describes an operation of the training component described for training the multimodal generation model 1920 as described with reference to FIG. 19. The method represents an example for training a reverse diffusion process as described above with reference to FIG. 14. In some examples, these operations are performed by a system including a processor executing a set of codes to control functional elements of an apparatus, such as the multimodal generation model described in FIGS. 9 and 19.

At operation 1805, the system initializes untrained model. In some cases, the operations of this step refer to, or may be performed by, a training component as described with reference to FIG. 19. Initialization can include defining the architecture of the model and establishing initial values for the model parameters. In some cases, the initialization can include defining hyper-parameters such as the number of layers, the resolution and channels of each layer block, the location of skip connections, and the like.

At operation 1810, the system adds noise to media item using forward diffusion process in N stages. In some cases, the operations of this step refer to, or may be performed by, a training component as described with reference to FIG. 19. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1815, the system at each stage n, starting with stage N, predict media item for stage n−1. In some cases, the operations of this step refer to, or may be performed by, a training component as described with reference to FIG. 19. In some cases, the media item is a synthetic image generated using the image generation model. For example, the reverse diffusion process can predict the noise that was added by the forward diffusion process, and the predicted noise can be removed from the noise input to obtain the predicted output. In some cases, an original media item is predicted at each stage of the training process.

At operation 1820, the system compares the predicted media item (or feature) at stage n−1 to media at stage n−1. In some cases, for example, the system compares the synthetic image (or predicted image feature) at state n−1 to the ground-truth image (or ground-truth feature) at state n−1. In some cases, the operations of this step refer to, or may be performed by, a training component as described with reference to FIG. 19. For example, given observed data x, the diffusion model may be trained to minimize the variational upper bound of the negative log-likelihood −log p_{θ}(x) of the training data.

At operation 1825, the system updates parameters of the model based on the comparison. In some cases, the operations of this step refer to, or may be performed by, a training component as described with reference to FIG. 19. For example, parameters of a U-Net may be updated using gradient descent. Time-dependent parameters of the Gaussian transitions can also be learned.

### System Apparatus

FIG. 19 shows an example of a multimodal processing apparatus 1900 according to aspects of the present disclosure. The example shown includes multimodal processing apparatus 1900, processor unit 1905, I/O module 1910, memory unit 1915, and training component 1925. Multimodal processing apparatus 1900 is an example of, or includes aspects of, the corresponding element described with reference to FIG. 1.

According to some embodiments of the present disclosure, multimodal processing apparatus 1900 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Multimodal processing apparatus 1900 is an example of, or includes aspects of, the corresponding element described with reference to FIG. 1.

Processor unit 1905 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 1905 is configured to operate a memory array using a memory controller. In other cases, a memory controller is integrated into the processor. In some cases, processor unit 1905 is configured to execute computer-readable instructions stored in a memory to perform various functions. In some embodiments, processor unit 1905 includes special-purpose components for modem processing, baseband processing, digital signal processing, or transmission processing. Processor unit 1905 is an example of, or includes aspects of, the processor described with reference to FIG. 20.

I/O module 1910 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 1910 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 1910 is an example of, or includes aspects of, the I/O interface described with reference to FIG. 20.

Examples of memory unit 1915 include random access memory (RAM), read-only memory (ROM), or a hard disk. Examples of memory unit 1915 include solid-state memory and a hard disk drive. In some examples, memory unit 1915 is used to store computer-readable, computer-executable software including instructions that, when executed, cause a processor to perform various functions described herein.

In some cases, memory unit 1915 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 1915 store information in the form of a logical state.

In one aspect, memory unit 1915 includes a machine learning model. In one aspect, the machine learning model includes a multimodal generation model 1920. Memory unit 1915 is an example of, or includes aspects of, the memory subsystem described with reference to FIG. 20. Machine learning model is an example of, or includes aspects of, the corresponding element described with reference to FIGS. 6-9.

In some cases, a machine learning model is a computational algorithm, model, or system designed to recognize patterns, make predictions, or perform a specific task (for example, multimodal processing) without being explicitly programmed. According to some aspects, the machine learning model is implemented as software stored in memory unit 1915 and executable by processor unit 1905, as firmware, as one or more hardware circuits, or as a combination thereof.

According to some embodiments of the present disclosure, the machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, the machine learning model includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behaviors and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important.

The attention mechanism involves a query, keys, and values denoted by Q, K, and V, respectively. Q is a matrix that contains the query (vector representation of one word in the sequence), K are the keys (vector representations of the words in the sequence), and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, which allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering the relevance of each input element with respect to the current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, the multimodal generation model is implemented as software stored in memory unit 1915 and executable by processor unit 1905, as firmware, as one or more hardware circuits, or as a combination thereof. According to some aspects, multimodal generation model 1920 obtains an input image and an image generation prompt, where the input image depicts an object and the image generation prompt describes a different view of the object. In some examples, multimodal generation model 1920 generates a set of custom tokens based on the input image, where the set of custom tokens includes an image generation token and an image understanding token. In some examples, multimodal generation model 1920 generates a synthetic image 975 based on the image generation prompt and the image generation token, where the synthetic image depicts the different view of the object described by the image generation prompt and preserves an identity of the object from the input image.

In some aspects, the image generation prompt includes a nonce token representing the object in the input image. In some examples, multimodal generation model 1920 divides a set of reference images into a set of groups based on the input image, where each of the set of groups is progressively more similar to the input image. In some examples, multimodal generation model 1920 generates a set of image generation tokens corresponding to the set of groups respectively, where the synthetic image is generated based on the set of image generation tokens 940.

In some examples, multimodal generation model 1920 selects an image generation task based on the image generation prompt. In some examples, multimodal generation model 1920 selects the image generation token for generating the synthetic image based on the image generation task. In some examples, multimodal generation model 1920 obtains an image understanding prompt including a question about the input image. In some examples, multimodal generation model 1920 generates a response to the image understanding prompt based on the image understanding token, where the response includes an answer to the question. In some aspects, the image generation token is based on an image reconstruction loss.

According to some aspects, multimodal generation model 1920 obtains an input image and an image understanding prompt, where the input image depicts an object and the image understanding prompt includes a question about the input image. In some examples, multimodal generation model 1920 generates a set of custom tokens based on the input image, where the set of custom tokens includes an image understanding token and an image generation token. In some examples, multimodal generation model 1920 generates a response to the image understanding prompt based on the image understanding token, where the response includes an answer to the question.

In some aspects, the image understanding prompt includes a nonce token representing the object in the input image. In some examples, multimodal generation model 1920 selects an image understanding task based on the image understanding prompt. In some examples, multimodal generation model 1920 selects the image understanding token for generating the response based on the image understanding task. In some examples, multimodal generation model 1920 obtains an image generation prompt describing a different view of the object. In some examples, multimodal generation model 1920 generates a synthetic image based on the image generation prompt and the image generation token, where the synthetic image depicts the different view of the object described by the image generation prompt and preserves an identity of the object from the input image.

In some examples, multimodal generation model 1920 divides a set of reference images into a set of groups based on the input image, where each of the set of groups is progressively more similar to the input image. In some examples, multimodal generation model 1920 generates a set of image generation tokens corresponding to the set of groups respectively, where the synthetic image is generated based on the set of image generation tokens. In some aspects, the image generation token is based on an image reconstruction loss. Multimodal generation model 1920 is an example of, or includes aspects of, the corresponding element described with reference to FIGS. 9 and 15.

According to some aspects, multimodal processing apparatus 1900 includes a training component 1925. The training component 1925 is implemented as software stored in memory unit 1915 and executable by processor unit 1905, as firmware, as one or more hardware circuits, or as a combination thereof. According to some embodiments, the training component 1925 is implemented as software stored in a memory unit and executable by a processor in the processor unit of a separate computing device, as firmware in the separate computing device, as one or more hardware circuits of the separate computing device, or as a combination thereof. In some examples, the training component 1925 is part of another apparatus other than multimodal processing apparatus 1900 and communicates with the multimodal processing apparatus 1900. In some examples, training component 1925 is part of multimodal processing apparatus 1900.

In some aspects, training component 1925 trains the multimodal generation model 1920 to select from among an image generation task and an image understanding task. In some aspects, training component 1925 trains the multimodal generation model 1920 to perform an image generation task based on the image generation token and to perform an image understanding task based on the image understanding token.

### Computing Device

FIG. 20 shows an example of a computing device according to aspects of the present disclosure. The example shown includes computing device, processor 2005, memory subsystem 2010, communication interface 2015, I/O interface 2020, user interface component 2025, and channel 2030.

In some embodiments, computing device is an example of, or includes aspects of, the multimodal processing apparatus described with reference to FIGS. 1 and 19. In some embodiments, computing device includes processor 2005 that can execute instructions stored in memory subsystem 2010 to obtain an input image and an image generation prompt, generate a set of custom tokens based on the input image, and generate a synthetic image based on the image generation prompt and the image generation token.

According to some embodiments, processor 2005 includes one or more processors. In some cases, processor 2005 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 2005 is configured to operate a memory array using a memory controller. In other cases, a memory controller is integrated into processor 2005. In some cases, processor 2005 is configured to execute computer-readable instructions stored in a memory to perform various functions. In some embodiments, processor 2005 includes special-purpose components for modem processing, baseband processing, digital signal processing, or transmission processing. Processor 2005 is an example of, or includes aspects of, the processor unit described with reference to FIG. 19.

According to some embodiments, memory subsystem 2010 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 2010 is an example of, or includes aspects of, the memory unit described with reference to FIG. 19.

According to some embodiments, communication interface 2015 operates at a boundary between communicating entities (such as computing device, one or more user devices, a cloud, and one or more databases) and channel 2030 and can record and process communications. In some cases, communication interface 2015 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 2015.

According to some embodiments, I/O interface 2020 is controlled by an I/O controller to manage input and output signals for computing device. In some cases, I/O interface 2020 manages peripherals not integrated into computing device. In some cases, I/O interface 2020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2020 or hardware components controlled by the I/O controller. I/O interface 2020 is an example of, or includes aspects of, the I/O module described with reference to FIG. 19.

According to some embodiments, user interface component 2025 enables a user to interact with computing device. In some cases, user interface component 2025 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over conventional technology (e.g., conventional image generation models). Example experiments demonstrate that the multimodal processing apparatus based on the present disclosure outperforms conventional image generation models. Details on the example use cases based on embodiments of the present disclosure are described with reference to FIGS. 6-8.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image and an image generation prompt, wherein the input image depicts a view of an object and the image generation prompt describes a different view of the object;
generating a set of custom tokens based on the input image, wherein the set of custom tokens includes an image generation token and an image understanding token; and
generating, using a multimodal generation model, a synthetic image based on the image generation prompt and the image generation token, wherein the synthetic image depicts the different view of the object described by the image generation prompt and preserves an identity of the object from the input image.

2. The method of claim 1, wherein:
the image generation prompt includes a nonce token representing the object in the input image.

3. The method of claim 1, wherein generating the set of custom tokens comprises:
dividing a set of reference images into a plurality of groups based on the input image, wherein each of the plurality of groups is progressively more similar to the input image; and
generating a plurality of image generation tokens corresponding to the plurality of groups respectively, wherein the synthetic image is generated based on the plurality of image generation tokens.

4. The method of claim 1, further comprising:
selecting an image generation task based on the image generation prompt; and
selecting the image generation token for generating the synthetic image based on the image generation task.

5. The method of claim 1, wherein:
the multimodal generation model is trained to select from among an image generation task and an image understanding task.

6. The method of claim 1, wherein:
the multimodal generation model is trained to perform an image generation task based on the image generation token and to perform an image understanding task based on the image understanding token.

7. The method of claim 1, further comprising:
obtaining an image understanding prompt comprising a question about the input image; and
generating, using the multimodal generation model, a response to the image understanding prompt based on the image understanding token, wherein the response includes an answer to the question.

8. The method of claim 1, wherein:
the image generation token is based on an image reconstruction loss.

9. A non-transitory computer readable medium storing code for multimodal processing, the code comprising instructions that, when executed by at least one processor, cause the at least one processor to perform operations comprising:
obtaining an input image and an image understanding prompt, wherein the input image depicts an object and the image understanding prompt comprises a question about the input image;
generating a set of custom tokens based on the input image, wherein the set of custom tokens includes an image understanding token and an image generation token; and
generating, using a multimodal generation model, a response to the image understanding prompt based on the image understanding token, wherein the response includes an answer to the question.

10. The non-transitory computer readable medium of claim 9, wherein:
the image understanding prompt includes a nonce token representing the object in the input image.

11. The non-transitory computer readable medium of claim 9, further comprising:
selecting an image understanding task based on the image understanding prompt; and
selecting the image understanding token for generating the response based on the image understanding task.

12. The non-transitory computer readable medium of claim 9, wherein:
the multimodal generation model is trained to select from among an image generation task and an image understanding task.

13. The non-transitory computer readable medium of claim 9, wherein:
the multimodal generation model is trained to perform an image generation task based on the image generation token and to perform an image understanding task based on the image understanding token.

14. The non-transitory computer readable medium of claim 9, the code further comprising instructions that, when executed by at least one processor, cause the at least one processor to perform operations comprising:
obtaining an image generation prompt describing a different view of the object; and
generating, using the multimodal generation model, a synthetic image based on the image generation prompt and the image generation token, wherein the synthetic image depicts the different view of the object described by the image generation prompt and preserves an identity of the object from the input image.

15. The non-transitory computer readable medium of claim 14, wherein generating the set of custom tokens comprises:
dividing a set of reference images into a plurality of groups based on the input image, wherein each of the plurality of groups is progressively more similar to the input image; and
generating a plurality of image generation tokens corresponding to the plurality of groups respectively, wherein the synthetic image is generated based on the plurality of image generation tokens.

16. The non-transitory computer readable medium of claim 14, wherein:
the image generation token is based on an image reconstruction loss.

17. A system comprising:
a memory component; and
a processing device coupled to the memory component, the processing device configured to perform operations comprising:
obtaining an input image and an image generation prompt, wherein the input image depicts a view of an object and the image generation prompt describes a different view of the object;
generating a set of custom tokens based on the input image, wherein the set of custom tokens includes an image generation token and an image understanding token; and
generating, using a multimodal generation model, a synthetic image based on the image generation prompt and the image generation token, wherein the synthetic image depicts the different view of the object described by the image generation prompt and preserves an identity of the object from the input image.

18. The system of claim 17, wherein the processing device is further configured to perform operations comprising:
obtaining an image understanding prompt comprising a question about the input image; and
generating, using the multimodal generation model, a response to the image understanding prompt based on the image understanding token, wherein the response includes an answer to the question.

19. The system of claim 17, wherein:
the multimodal generation model includes a transformer model for performing an image understanding task.

20. The system of claim 17, wherein:
the multimodal generation model includes a diffusion model for performing an image generation task.
